(19) United States
(12) Patent Application Publication
(10) Pub. No.: US 2024/0099298 A1
(43) Pub. Date: Mar. 28, 2024

(54) BIOINSECTICIDAL COMPOSITIONS CONTAINING MONOTERPENES AND METHODS OF USE THEREOF

(71) Applicant: University of Hawaii, Honolulu, HI (US)

(72) Inventor: Qing X. LI, Honolulu, HI (US)

(21) Appl. No.: 18/513,938

(22) Filed: Nov. 20, 2023

Related U.S. Application Data
(63) Continuation-in-part of application No. 16/760,675, filed on Apr. 30, 2020.
(60) Provisional application No. 62/581,225, filed on Nov. 3, 2017.

(51) Int. Cl. A01N 35/06; A01N 31/02; A01N 31/06; A01N 31/14; A01N 43/30; A01N 43/32; A01P 7/04

(52) U.S. Cl. CPC A01N 35/06; A01N 31/02; A01N 31/06; A01N 31/14; A01N 43/30; A01N 43/32; A01P 7/04

(57) ABSTRACT

Bioinsecticidal compositions and methods of use of the same are provided, which include monoterpenes that target GABA receptor-associated protein.

### INTRODUCTION

This application is a continuation-in-part application of U.S. application Ser. No. 16/760,675, filed Apr. 30, 2020, which is an U.S. National Stage Application of PCT/US2018/058636, filed Nov. 1, 2018, and claims the benefit of priority of U.S. Provisional Application No. 62/581,225, filed Nov. 3, 2017, the contents of which are incorporated herein by reference in their entirety.

### BACKGROUND

Synthetic insecticides raise concerns about food contamination, environmental pollution and ecological adverse effects. In addition, heavy use of synthetic insecticides has led to the development of insect resistance. Such problems and concerns require development of effective natural insecticides. Botanicals offer an alternative to synthetic insecticides, as they may exhibit lower mammalian toxicity.

Studies have reported that essential oils and their components are toxic to insect pests at different life stages. In this respect, several studies have focused on the potential use of essential oils in biological control of different insect pests. For example, Artemisia sieberi essential oil can be a control agent against stored-product insects. Citrus sinensis essential oil can control Musca domestica adults and inhibit P450. Cymbopogon citrates essential oil and its major components, citral and 1,8-cineole, are insecticidal to housefly. Thyme and lemongrass essential oils are also active against larvae and an ovarian cell line of the cabbage looper correlation between insecticidal activity and cytotoxicity, which the latter limits them as insecticides. Essential oil from Alpinia purpurata inflorescences can control Sitophilus zeamais (maize weevil) and kill S. zeamais adults with a median lethal concentration (LC₅₀) of 41.4 mL/L in air. Eucalyptus essential oils have fumigation toxicity against Ectomyelois ceratoniae under various conditions. Further, essential oil nanoformulations have been used to control the storage pests Tribolium castaneum and Rhizopertha dominica.

While the chemical composition and insecticidal properties of essential oils have been investigated, the effectiveness of individual terpenoids against specific pest insects remains species-specific. For example, linalool and (−)-pulegone have been shown to exhibit fumigant toxicity against palm Thrips (Kim, et al. (2015) Pest. Manag. Sci. 71:1292-1296); pulegone, carvacrol, trans-anethole and linalool are toxic to mosquitoes (Dias, et al. (2014) Parasitol. Res. 113:565-592; Waliwitiya, et al. (2009) Pest Management Sci. 65(3):241-248); trans-anethole has been shown to exhibit fumigant activity against Blattella germanica (Chang & Ahn (2001) Pest Management Sci. 58:161-166); carvacrol, thymol and citral exhibit toxicity against Pochazia shantungensis (Park, et al. (2017) Sci. Rep. 7:40902); trans-anethole, estragole, and (+)-fenchone are active against Sitophilus oryzae, Callosobruchus chinensis and Lasioderma serricorne in a fumigation test (Kim & Ahn (2001) Pest Manag. Sci. 57(3):301-6); and one or more of pulegone, linalool and l-fenchone have fumigation toxicity against rice weevil, red flour beetle, sawtoothed grain beetle, housefly and German cockroach (Lee, et al. (2003) J. Stored Prod. Res. 77-85). Further, oxygenated monoterpenes have been suggested to have a high potential for control of S. zeamais adults. Moreover, basil oil and its three major active constituents (trans-anethole, estragole, and linalool) exhibit insecticidal activity against the tephritid fruit fly species Ceratitis capitata (Wiedemann), Bactrocera dorsalis (Hendel), and Bactrocera cucurbitae (Coquillett) (Chang, et al. (2009) J. Econ. Entomol. 102(1):203-209).

### SUMMARY OF THE INVENTION

A method for controlling an insect pest in a space or soil infested with the insect pest by fumigating the space or soil with a bioinsecticidal composition including an effective amount of a monoterpene of Formula I, thereby controlling the insect pest in the space or soil. In some aspects, the monoterpene of Formula I is pulegone or methyl eugenol. In some aspects, the insect pest is a thrip, fruit fly of the genus Drosophila, and/or white fly.

The invention also provides a method for controlling an insect pest in a space or soil infested with the insect pest by fumigating the space or soil with a monoterpene that binds to a GABA receptor-associated protein of the insect pest thereby controlling the insect pest in the space of soil. In some aspects, the monoterpene has the structure of Formula I. In some aspects, the monoterpene of Formula I is pulegone or methyl eugenol. In some aspects, the insect pest is a thrip, fruit fly of the genus Drosophila, and/or white fly.

### BRIEF DESCRIPTION OF THE DRAWINGS

FIG. 1 shows a comparison of the 24-hour fumigation toxicity of (+)-pulegone, (−)-pulegone, racemic (+)/(−)-pulegone, in comparison with DDVP (i.e., dichlorvos), to the Thrips Megalurothrips usitatus and of (+)-pulegone to the Italian honeybee Apis mellifera. The mortality for A. mellifera at 0.2 μL/dm³ of (+)-pulegone was 3% relative to no chemical control. Experiments were done with 20 bees per group in triplicate.

### DETAILED DESCRIPTION OF THE INVENTION

Botanical insecticides are needed to selectively and effectively control one or a number of insect pests. It has now been shown that certain monoterpenes are of use in selectively controlling agricultural, storage, and household insect pests. The fumigation toxicity of these monoterpenes appears to be related to their structures. Most of the monoterpenes tested exhibit good-to-moderate toxicity against the test pests and low toxicity to the insect natural enemy species. In particular, (+)-pulegone and estragole are highly toxic to adult pests even at low concentrations. Carvacrol is effective against household pests, and linalool was found to control both Thrips and leafhopper in field tests. In addition, the insecticidal activity of anethole, linalool and methyl eugenol (ME) was evaluated against western flower Thrips (Frankliniella occidentalis). The half-maximum lethal concentration (LC₅₀) of ME against second-instar nymphs of F. occidentalis was 5.5 mg/L using membrane and leaf immersion methods, while that of spinosyn A was 1.0 mg/L. The dissociation constants of ME binding to recombinant gamma-aminobutyric acid receptor-associated protein (rGABARAP) were 1.30 and 4.22 μmol/L, respectively, according to microscale thermophoresis (MST) and isothermal titration calorimetry (ITC) measurements. Similar results were observed for pulegone. The results presented herein indicate that GABARAP is a potent target for monoterpenoid insecticides, in particular as fumigants.

Accordingly, the present invention provides bioinsecticidal compositions and methods for combating or controlling one or more insect pests in a location susceptible to the presence or incursion thereof, e.g., soil or enclosed space, using an effective, insect-controlling amount of a monoterpene, in particular as a fumigant. In some embodiments, the monoterpene of use in the methods of the invention has the structure of Formula I:

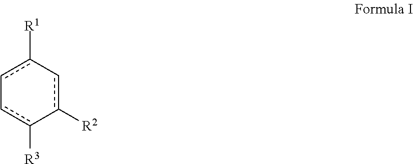

wherein dashed bonds are independently present or absent; R¹ and R³ are independently alkyl, alkenyl, or alkoxyl; R² is, when allowed by available valences, hydrogen, hydroxyl (—OH), or oxo (═O); and tautomers, isomers and enantiomers thereof.

The term “alkyl” as used herein refers to a saturated linear or branched-chain monovalent hydrocarbon radical of one to twelve (e.g. , 2 to 10, 2 to 9, 2 to 8, 3 to 8, 4 to 8, or any range therein) carbon atoms, wherein the alkyl radical may be optionally substituted independently with one or more substituents described below. Examples of alkyl groups include, but are not limited to, methyl (Me, —CH₃), ethyl (Et, —CH₂CH₃) 1-propyl (n-Pr, n-propyl, —CH₂CH₂CH₃), 2-propyl (i-Pr, i-propyl, —CH (CH₃)₂), 1-butyl (n-Bu, n-butyl, —CH₂CH₂CH₂CH₃)₂-methyl-1-propyl (i-Bu, i-butyl, —CH₂CH(CH₃)₂) 2-butyl (s-Bu, s-butyl, —CH(CH₃)CH₂CH₃) 2-methyl-2-propyl (t-Bu, t-butyl, —C(CH₃)₃) 1-pentyl (n-pentyl, —CH₂CH₂CH₂CH₂CH₃), 2-pentyl (—CH(CH₃)CH₂CH₂CH₃) 3-pentyl (—CH(CH₂CH₃)₂) , 2-methyl-2-butyl (—C(CH₃)₂CH₂CH₃), 3-methyl-2-butyl (—CH(CH₃)CH(CH₃)₂), 3-methyl-1-butyl (—CH₂CH₂CH(CH₃)₂), 2-methyl-1-butyl (—CH₂CH(CH₃)CH₂CH₃) 1-hexyl (—CH₂CH₂CH₂CH₂CH₂CH₃), 2-hexyl (—CH(CH₃)CH₂CH₂CH₂CH₃), 3-hexyl (—CH(CH₂CH₃) (CH₂CH₂CH₃)), 2 -methyl-2-pentyl (—C(CH₃)₂CH₂CH₂CH₃), 3-methyl-2-pentyl (—CH(CH₃)CH(CH₃)CH₂CH₃), 4-methyl-2-pentyl (—CH(CH₃)CH₂CH(CH₃)₂) 3-methyl-3-pentyl (—C (CH₃) (CH₂CH₃)₂) ethyl-3-pentyl (—CH(CH₂CH₃)CH(CH₃)₂), 2,3-dimethyl-2-butyl (—C(CH₃)₂CH(CH₃)₂), 3,3-dimethyl-2-butyl (—CH(CH₃)C(CH₃)₃, 1-heptyl, 1-octyl, and the like.

The term “alkenyl” as used herein refers to a linear or branched-chain monovalent hydrocarbon radical of two to twelve (e.g., 2 to 10, 2 to 9, 2 to 8, 3 to 8, 4 to 8, or any range therein) carbon atoms with at least one site of unsaturation, i.e., a carbon-carbon, sp 2 double bond, wherein the alkenyl radical may be optionally substituted independently with one or more substituents described herein, and includes radicals having “cis” and “trans” orientations, or alternatively, “E” and “Z” orientations. Examples include, but are not limited to, ethylenyl or vinyl (—CH═CH₂), allyl (—CH₂CH═CH₂), 1-propenyl, 1-buten-1-yl, 1-buten-2-yl, and the like.

The term “alkoxyl” refers to —O-alkyl, wherein alkyl is as defined herein. Examples of this group include methoxyl group, ethyoxyl, propoxyl group, butoxyl group, etc.

In some embodiments, the monoterpene of Formula I is (+)-pulegone, carvacrol, linalool, trans-anethole, methyl eugenol or estragole. In some embodiments, the monoterpene of Formula I is (+)-pulegone, (−)-pulegone, methyl eugenol, or a combination thereof.

In some embodiments, the monoterpene of Formula I exerts its insecticidal activity by binding to GABA receptor-associated protein (GABARAP). In some embodiments, the monoterpene of Formula I binds to GABA receptor-associated protein (GABARAP), but does not exert its activity via the octopamine receptor, tyramine receptor and/or an olfactory receptor.

The term “bioinsecticide” or “bioinsecticidal” composition as used herein refers to a chemical substance of natural origin that can be optionally synthesized and used in the control of agricultural, natural environmental, storage, and/or domestic/household pests by exerting insecticidal activity. In some embodiments, a “bioinsecticide” kills an insect rather than merely repelling the insect. In accordance with the present invention the bioinsecticide composition is at least one of (+)/(−)-pulegone, carvacrol, linalool, trans-anethole, methyl eugenol and/or estragole. In some embodiments, the bioinsecticide composition is (+)/(−)-pulegone, methyl eugenol and/or linalool. In some embodiments, the bioinsecticide composition is (+)/(−)-pulegone and/or methyl eugenol. In certain embodiments, the monoterpene used in accordance with the present invention is pure. More specifically, the monoterpene used is at least 95%, 96%, 97%, 98%, 99% or 99.9% homogenous to the monoterpene of interest. In this respect, the bioinsecticide composition consists of one or a combination of compounds of Formula I and does not include any other compound exhibiting insecticidal activity.

The amount of monoterpene present in the bioinsecticidal composition is an amount as low as 1 wt. %, in an amount as low as 5 wt. %, or in an amount as low as 10 wt. %. The monoterpene can be included in an amount that is as high as 70 wt. %, in an amount as high as 80 wt. %, or in an amount as high as 99 wt. %. The monoterpene may further be present within any range delimited by any pair of the foregoing values, such as between 1 wt. % and 99 wt. %, or between 10 wt. % to 70 wt. %, for example.

An insecticide is rarely suitable for application in its pure form. It is usually necessary to add other substances such as carriers or diluents so that the insecticide can be used at the required concentration and in an appropriate form, permitting ease of application, handling, transportation, storage, and maximum pesticide activity. Thus, the bioinsecticidal compositions of this invention are formulated to include at least one monoterpene of Formula I (e.g., (+)-pulegone, carvacrol, linalool, trans-anethole, estragole, methyl eugenol, or a combination thereof) in admixture with a carrier or diluent, preferably wherein the carrier or diluent does not exhibit insecticidal activity. The carrier or diluent of this invention is preferably an inert material, organic or inorganic, with which an active ingredient can be mixed or formulated to facilitate its application, storage, transport, and/or handling, or improve various product characteristics such as its odor. Commonly used carriers and diluents include, but are not limited to, ethanol, isopropanol, other alcohols, water, nanoparticles and nanotubes. Exemplary carriers that can be used include inert carriers listed by the U.S. EPA as a Minimal Risk Inert Pesticide Ingredients (4A), Inert Pesticide Ingredients (4B) or under EPA regulation 40 CFR 180.950, and include for example, citric acid, lactic acid, glycerol, castor oil, benzoic acid, carbonic acid, ethoxylated alcohols, ethoxylated amides, glycerides, benzene, butanol, 1-propanol, hexanol, other alcohols, dimethyl ether, and polyethylene glycol. In particular embodiments, the at least one monoterpene is formulated as the core material of a nanoparticle or nanotube.

The bioinsecticidal compositions of this invention can be formulated into solid, gaseous or liquid forms, for example, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultralow volume solutions. For further information on formulation types, see “Catalogue of pesticide formulation types and international coding system,” Technical Monograph no 2, 7^{th} Edition by CropLife International (March 2017). In certain embodiments, the bioinsecticidal composition of this invention is in a liquid or gaseous form.

A bioinsecticidal composition can be applied as an aqueous suspension or emulsion prepared from a concentrated formulation containing a monoterpene. Such water-soluble, water-suspendable, or emulsifiable formulations, are either solids, usually known as wettable powders, or water dispersible granules, or liquids usually known as emulsifiable concentrates, or aqueous suspensions. Wettable powders, which may be compacted to form water dispersible granules, include an intimate mixture of the monoterpene, a carrier, and one or more surfactants. The concentration of the monoterpene is usually from about 10% to about 90% by weight. The carrier is usually chosen from among the attapulgite clays, the montmorillonite clays, the diatomaceous earths, the purified silicates, nanoparticles or nanotubes. Effective surfactants, constituting from about 0.5% to about 10% of the wettable powder, are found among sulfonated lignins, condensed naphthalenesulfonates, naphthalenesulfonates, alkylbenzenesulfonates, alkyl sulfates, and nonionic surfactants such as ethylene oxide adducts of alkyl phenols.

Emulsifiable concentrates provide a convenient concentration of a monoterpene, such as from about 50 to about 500 grams per liter of liquid dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are chosen from conventional anionic and nonionic surfactants.

Aqueous suspensions include suspensions of water-insoluble monoterpenes dispersed in an aqueous carrier at a concentration in the range from about 5% to about 50% by weight. Suspensions are prepared by combining the monoterpene and vigorously mixing it into a carrier composed of water and surfactants. Inert ingredients, such as inorganic salts and synthetic or natural gums, may also be added, to increase the density and viscosity of the aqueous carrier.

Monoterpenes may also be applied as granular compositions that are particularly useful for applications to the soil. Granular compositions usually contain from about 0.5% to about 10% by weight of the monoterpene, dispersed in a carrier such as clay or a similar substance. Such compositions are usually prepared by dissolving the monoterpene in a suitable solvent and applying it to a granular carrier which has been pre-formed to the appropriate particle size, in the range of from about 0.5 to 3 mm. Such compositions may also be formulated by making a dough or paste of the carrier and monoterpene and crushing and drying to obtain the desired granular particle size.

Dusts containing a monoterpene are prepared by intimately mixing the monoterpene in powdered form with a suitable dusty agricultural carrier, such as kaolin clay, ground volcanic rock, and the like. Dusts can suitably contain from about 1% to about 10% of the monoterpene. They can be applied as a seed dressing, or as a foliage application with a dust blower machine.

It is equally practical to apply a monoterpene in the form of a solution in an appropriate inert organic solvent, such as petroleum oil, corn oil, or peanut oil, which are widely used in agricultural chemistry.

Monoterpenes can also be applied in the form of an aerosol composition. In such compositions the monoterpene is dissolved or dispersed in a carrier, which is a pressure-generating propellant mixture. The aerosol composition is packaged in a container from which the mixture is dispensed through an atomizing valve.

In some embodiments, the monoterpene of Formula I is provided in the form of a residual insecticide or contract insecticide. Residual insecticides remain effective where they are applied for some length of time. The length of time depends on the formulation (dust, liquid, etc.), the type of surface (soil, brick, wood, etc.) and the condition of the surface (wet, greasy, etc.). By comparison, contact insecticides kill by contact. Contact insecticides are meant for killing crawling or flying insects that have been spotted.

In some embodiments, the monoterpene of Formula I is provided in the form of a fumigant. Fumigants are toxic, volatile gases that kill target insects in confined spaces or soil in gaseous form without direct physical contact with the target pest. The objective is to maintain a lethal concentration of a fumigant long enough to kill most insect pests. Resistance to fumigants tends to develop slowly especially when fumigations kill all of the pest insects. Like residual insecticides, fumigants are inexpensive. Unlike residual insecticides, fumigants leave little chemical residue, and provide no long-term protection.

Fumigant forms of insecticides have a relatively high vapor pressure and hence can exist as a gas in sufficient concentrations to kill insects in soil or enclosed spaces. The toxicity of the fumigant is proportional to its concentration and the exposure time. They are characterized by a good capacity for diffusion and act by penetrating the pest's respiratory system or being absorbed through the pest's cuticle. Fumigants are applied to control insects under gas proof sheets, in gas sealed rooms or buildings or in special chambers.

Monoterpenes can be microencapsulated by suspending the monoterpene droplets in plastic polymers of various types. By altering the chemistry of the polymer or by changing factors in the processing, microcapsules can be formed of various sizes, solubility, wall thicknesses, and degrees of penetrability. These factors govern the speed with which the active ingredient within is released, which in turn, affects the residual performance, speed of action, and odor of the product.

Oil solution concentrates are made by mixing a monoterpene in a solvent that will hold the monoterpene in solution. Advantages of oil solutions include better storage stability, better penetration of crevices, and better adhesion to greasy surfaces.

Another embodiment is an oil-in-water emulsion, wherein the emulsion includes oily globules which are each provided with a lamellar liquid crystal coating and are dispersed in an aqueous phase. In accordance with this embodiment, each oily globule includes at least one monoterpene, and is individually coated with a monolamellar or oligolamellar layer including: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in US 2007/0027034.

In any of these forms, the bioinsecticidal composition can include a propellant, so that they can be aerosolized. Such aerosolized compositions can be used in fumigation applications, such as ship/air cargo or food containment areas. The bioinsecticidal composition can also be used as a pesticide treatment prior to transporting items. In one embodiment, the bioinsecticidal composition is converted to an aerosol composition by adding nitrogen to the formula, and keeping the contents in a pressurized container, such as a metal can. Nitrogen is an inert additive, and not a green-house gas, and can be preferred over other propellants, such as low molecular weight hydrocarbons. When present, the nitrogen is present in an amount of up to 10 percent, though is typically in the range of about 0.5% by weight of the bioinsecticidal composition. The aerosol composition can also include a propellant other than nitrogen, such as n-propane, n-butane, iso-pentane, iso-butane, n-pentane or hydrofluorocarbons.

In addition to at least one monoterpene and a suitable carrier or diluent, the bioinsecticidal composition of this invention can contain other inert components. These inert components include, but are not limited to, wetters, spreaders, stickers, penetrants, buffers, sequestering agents, drift reduction agents, compatibility agents, anti-foam agents, cleaning agents, dispersants or surfactants, thixotropic agents, and emulsifiers. The amount of the additional component used can be in an amount as low as 0.01 wt. %, in an amount as low as 0.1 wt. %, or in an amount as low as 1 wt. %. The additional component can be included in an amount that is as high as 15 wt. %, in an amount as high as 30 wt. %, or in an amount as high as 50 wt. %. The additional component may further be present within any range delimited by any pair of the foregoing values, such as between 0.01 wt. % and 30 wt. %, or between 0.1 wt. % to 15 wt. %, for example.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations include sodium lauryl sulphate, sodium dioctyl sulphosuccinate, alkyl phenol ethoxylates, and aliphatic alcohol ethoxylates.

A dispersing agent is a substance which adsorbs onto the surface of a particle and helps to preserve the state of dispersion of the particle and prevents it from reaggregating. Dispersing agents are added to formulations to facilitate dispersion and suspension during manufacture, and to ensure the particles redisperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. Very high molecular weight polymeric surfactants have also been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Exemplary dispersing agents used in the formulations of this invention include sodium lignosulphonates, sodium naphthalene sulphonate formaldehyde condensates, tristyrylphenol ethoxylate phosphate esters, aliphatic alcohol ethoxylates, alky ethoxylates, EO-PO block copolymers, and graft copolymers.

An emulsifying agent is a substance which stabilizes a suspension of droplets of one liquid phase in another liquid phase. Without the emulsifying agent the two liquids would separate into two immiscible liquid phases. The most commonly used emulsifier blends contain alkylphenol or aliphatic alcohol with 12 or more ethylene oxide units and the oil-soluble calcium salt of dodecylbenzene sulphonic acid. A range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. The type of surfactants usually used for solubilization are non-ionics such as sorbitan monooleates, sorbitan monooleate ethoxylates, and methyl oleate esters.

Surfactants are sometimes used, either alone or with other additives such as mineral or vegetable oils as adjuvants to spray-tank mixes to improve the biological performance of the insecticide on the target. The types of surfactants used for bioenhancement depend generally on the nature and mode of action of the insecticide. However, they are often non-ionics such as alky ethoxylates, linear aliphatic alcohol ethoxylates, or aliphatic amine ethoxylates.

Organic solvents are used mainly in the formulation of emulsifiable concentrates, ULV formulations, and to a lesser extent granular formulations. Sometimes mixtures of solvents are used. The first main groups of solvents are aliphatic paraffinic oils such as kerosene or refined paraffins. The second main group, and the most common, includes the aromatic solvents such as xylene and higher molecular weight fractions of C₉ and C₁₀ aromatic solvents. Chlorinated hydrocarbons are useful as cosolvents to prevent crystallization of insecticides when the formulation is emulsified into water. Alcohols are sometimes used as cosolvents to increase solvent power.

Thickeners or gelling agents are used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g., bentonite; magnesium aluminum silicate; and attapulgite. Water-soluble polysaccharides have also been used as thickening-gelling agents. The types of polysaccharides most commonly used are natural extracts of seeds and seaweeds or are synthetic derivatives of cellulose. Examples of these types of materials include, but are not limited to, guar gum, locust bean gum, carrageenan, alginates, methyl cellulose, sodium carboxymethyl cellulose (SCMC), and hydroxyethyl cellulose (HEC). Other types of anti-settling agents are based on modified starches, polyacrylates, polyvinyl alcohol and polyethylene oxide. Another good anti-settling agent is xanthan gum.

Microorganisms cause spoilage of formulated products. Therefore, preservation agents can be included to eliminate or reduce their effect. Examples of such agents include, but are limited to, propionic acid and its sodium salt, sorbic acid and its sodium or potassium salts, benzoic acid and its sodium salt, p-hydroxy benzoic acid sodium salt, methyl p-hydroxy benzoate, and 1,2-benzisothiazalin-3-one (BIT).

The presence of surfactants, which lower interfacial tension, often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane while the non-silicone anti-foam agents are water-insoluble oils, such as octanol and nonanol, or silica. In both cases, the function of the anti-foam agent is to displace the surfactant from the air-water interface.

In one embodiment, the bioinsecticidal compositions include a thixotropic agent. In this embodiment, mechanical agitation, such as that which occurs when the compositions are sprayed, liquefies the compositions and allows them to be applied in aerosol form. When the mechanical agitation is stopped, the compositions then return to their original state, for example, a gel. The use of a thixotropic agent can enable the formulations to be prepared without using any oil, and enables the active components to stick on plant surfaces, and protect the plants from insect damage.

While it can be preferred in some embodiments for the bioinsecticidal compositions to be capable of being organically certified, as including only natural ingredients, in another embodiment, an additional repellent or cidal agent is included, which is a non-naturally occurring substance. Representative repellent and cidal agents include compounds or compositions that are used as acaricides, insecticides, insecticide synergists, and ixodicides. Chemical classes of insecticides include 2-dimethylaminopropane-1,3-dithiol, 2-dimethylaminopropane-1,3-dithiol analogs, amidines, arylpyrroles, avermectin, benzoylureas, carbamates, carbamoyl-triazoles, cyclodienes, diacylhydrazines, dinitrophenols, fiprole, METI, neonicotinoids, non-ester pyrethroids, organochlorines, organophosphates, oxadiazines, oximes, carbamates, pyrethroids, and spinosyns. Suitable insecticides include 1,1-bis(4-chlorophenyl)-2-ethoxyethanol, 1,1-dichloro-1-nitroethane, 1,1-dichloro-2,2-bis(4-ethylphenyl)ethane, 1,2-dichloropropane with 1,3-dichloropropene, 1-bromo-2-chloroethane, 2-(1,3-dithiolan-2-yl)phenyl dimethylcarbamate, 2-(2-butoxyethoxy)ethyl thiocyanate, 2-(4,5-dimethyl-1,3-dioxolan-2-yl)phenyl methylcarbamate, 2-(4-chloro-3,5-xylyloxy)ethanol, 2,2,2-trichloro-1-(3,4-dichlorophenyl)ethyl acetate, 2,2-dichlorovinyl 2-ethylsulfinylethyl methyl phosphate, 2,4-dichlorophenyl benzenesulfonate, 2-chlorovinyl diethyl phosphate, 2-isovalerylindan-1,3-dione, 2-methyl(prop-2-ynyl)aminophenyl methylcarbamate, 2-thiocyanatoethyl laurate, 3-bromo-1-chloroprop-1-ene, 3-methyl-1-phenylpyrazol-5-yl dimethylcarbamate, 4-chlorophenyl phenyl sulfone, 4-methyl(prop-2-ynyl)amino-3,5-xylyl methylcarbamate, 4-methylnonan-5-ol with 4-methylnonan-5-one, 5,5-dimethyl-3-oxocyclohex-1-enyl dimethylcarbamate, 6-methylhept-2-en-4-ol, abamectin, acephate acequinocyl, acrinathrin, alanycarb, aldicarb, aldoxycarb, aldrin, allethrin [(1R)-isomers], allyxycarb, alpha-cypermethrin, amidithion, amidothioate, aminocarb, amiton, amiton hydrogen oxalate, amitraz, anabasine, aramite, athidathion, azadirachtin, azamethiphos, azinphos-ethyl, azinphos-methyl, azocyclotin, azothoate, barium polysulfide, Bayer 22/190, Bayer 22408, bendiocarb, benfuracarb, bensultap, benzoximate, beta-cyfluthrin, beta-cypermethrin, bifenazate, bifenthrin, binapacryl, biopermethrin, bis(2-chloroethyl)ether, bistrifluoron, bromfenvinfos, bromocyclen, bromophos, bromophos-ethyl, bromopropylate, bufencarb, buprofezin, butacarb, butathiofos, butocarboxim, butonate, butoxycarboxim, cadusafos, calcium polysulfide, camphechlor, carbanolate, carbaryl, carbofuran, carbophenothion, carbosulfan, cartap hydrochloride, CGA 50 439, chinomethionat, chlorbenside, chlorbicyclen, chlordane, chlordecone, chlordimeform; chlordimeform hydrochloride, chlorethoxyfos, chlorfenapyr, chlorfenethol, chlorfenson, chlorfensulphide, chlorfluazuron, chlormephos, chlorobenzilate, chloromebuform, chloropropylate, chlorphoxim, chlorprazophos, chlorpyrifos, chlorpyrifos-methyl, chlorthiophos, chromafenozide, cloetho-carb, clofentezine, clothianidin, codlemone, coumaphos, coumithoate, crotoxyphos, crufomate, cryolite, CS 708, cyanofenphos, cyanophos, cyanthoate, cycloprothrin, cyfluthrin, cyhalothrin, cyhexatin, cypermethrin, cyphenothrin [(1R)-trans-isomers], cyromazine, DAEP, dazomet, DCPM, DDT, decarbofuran, deltamethrin, demephion; demephion-O; demephion-S, demeton; demeton-O; demeton-S, demeton-S-methyl, demeton-S-methylsulphon, diafenthiuron, dialifos, diazinon, dicapthon, dichlorvos, dicofol, dicrotophos, dicyclanil, dieldrin, dienochlor, diethyl 5-methyl-pyrazol-3-yl phosphate, diflubenzuron, dimefox, dimethoate, dimethrin, dimethylvinphos, dimetilan, dinex; dinex-diclexine, dinobuton, dinocap, dinocton, dinopenton, dinoprop, dinosulfon, dinotefuran, dinoterbon, dioxabenzofos, dioxacarb, dioxathion, diphenyl sulfone, disulfoton, dithicrofos, DNOC, dodec-8-enyl acetate, dofenapyn, DSP, EI 1642, emam ectin benzoate, EMPC, empenthrin [(EZ)-(1R)-isomers], endosulfan, endothion, endrin, ENT 8184, EPBP, EPN, esfenvalerate, ethio-fencarb, ethion, ethiprole, ethoate-methyl, ethoprophos, etofenprox, etoxazole, etrimfos, famphur, fenazaflor, fenazaquin, fenbutatin oxide, fenchlorphos, fenethacarb, fenfluthrin, fenitrothion, fenobucarb, fenothio-carb, fenoxacrim, fenoxycarb, fenpirithrin, fenpropathrin, fenpyroximate, fenson, fensulfothion, fenthion, fentrifanil, fenvalerate, fipronil, flonicamid, fluacrypyrim, flubenzimine, flucofuron, flucycloxuron, flucythrinate, fluenetil, flufenoxuron, flufenprox, flumethrin, fluorbenside, fluvalinate, FMC 1137, fonofos, formetanate, formothion, formparanate, fosmethilan, fospirate, fosthiazate, fosthietan, furathiocarb, furethrin, gamma-cyhalo-thrin, gamma-HCH, glyodin, GY-81, halfenprox, halofenozide, heptachlor, heptenophos, hexadecyl cyclopropanecarboxylate, hexaflumuron, hexythiazox, hydramethylnon, hydroprene, hyquincarb, imidacloprid, imiprothrin, indoxacarb, iprobenfos, IPSP, isazofos, isobenzan, isodrin, isofenphos, isolane, isoprocarb, isopropyl O-(methoxyaminothio-phosphoryl)salicylate, isothioate, isoxathion, jodfenphos, kelevan, kinoprene, lambda-c yhalothrin, leptophos, lirimfos, lufenuron, lythidathion, m-cumenyl methylcarbamate, malathion, malonoben, mazidox, MB-599, mecarbam, mecarphon, menazon, mephosfolan, mercurous chloride, mesulfenfos, metam, methacrifos, methamidophos, methanesulfonyl fluoride, methidathion, methiocarb, methocrotophos, methomyl, methoprene, methoquin-butyl, methothrin, methoxychlor, methoxyfenozide, methyl isothiocyanate, metolcarb, metoxadiazone, mevinphos, mexacarbate, milbemectin, mipafox, mirex, MNFA, monocrotophos, morphothion, naled, naphthalene, nicotine, nifluridide, nitenpyram, nithiazine, nitrilacarb; nitrilacarb 1:1 zinc chloride complex, nornicotine, novaluron, noviflumuron, O,O,O,O′-tetrapropyl dithiopyrophosphate, O,O-diethyl O-4-methyl-2-oxo-2H-chromen-7-yl phosphorothioate, O,O-diethyl O-6-methyl-2-propylpyrimidin-4-yl phosphorothioate, O-2,5-dichloro-4-iodophenyl O-ethyl ethylphosphonothioate, oleic acid (fatty acids), omethoate, oxabetrinil, oxamyl, oxydemeton-methyl, oxydeprofos, oxydisulfoton, parathion, parathion-methyl, pentachlorophenol, permethrin, petroleum oils, phenkapton, phenothrin [(1R)-trans-isomer], phenthoate, phorate, phosalone, phosfolan, phosmet, phosnichlor, phosphamidon, phosphine, phoxim, phoxim-methyl, piperonyl butoxide, pirimetaphos, pirimicarb, pirimiphos-ethyl, pirimiphos-methyl, polychlorodicyclopentadiene isomers, polynactins, prallethrin, primidophos, proclonol, profenofos, promacyl, promecarb, propaphos, propargite, propetamphos, propoxur, prothidathion, prothiofos, prothoate, pymetrozine, pyraclofos, pyresmethrin, pyrethrins (pyrethrum), pyridaben, pyridalyl, pyridaphen thion, pyrimidifen, pyrimitate, pyriproxyfen, quinalphos, quinalphos-methyl, quinothion, quintiofos, R-1492, RA-17, resmethrin, rotenone, RU 15525, RU 25475, 5421, sabadilla, schradan, silafluofen, SN 72129, sodium fluoride, sodium hexafluorosilicate, sodium selenate, sophamide, spinosad, spirodiclofen, spiromesifen, spirotetramat (BYI8330), SSI-121, sulcofuron-sodium, sulfluramid, sulfosulfuron, sulfotep, sulfur, sulprofos, SZI-121, taroils, tazimcarb, TDE, tebufenozide, tebufenpyrad, tebupirimfos, teflubenzuron, tefluthrin, temephos, TEPP, terallethrin, terbufos, tetrachlorvinphos, tetradifon, tetramethrin, tetramethrin [(1R)-isomers], tetrasul, theta-cypermethrin, thiacloprid, thiamethoxam, thicrofos, thiocarboxime, thiocyclam, thiodicarb, thiofanox, thiometon, thionazin, thioquinox, thiosultap-sodium, tolfenpyrad, tralomethrin, transfluthrin, transpermethrin, triamiphos, triarathene, triazamate, triazophos, trichlorfon, trichloronat, trifenofos, triflumuron, trimedlure, trimethacarb, vamidothion, XMC, xylylcarb, zeta-cypermethrin, zolaprofos, and ZXI 8901. In particular embodiments, the present invention provides a synergistic bioinsecticidal composition comprising or consisting essentially of (+)-pulegone and piperonyl butoxide.

The bioinsecticidal compositions of the invention can be formulated for indoor or outdoor use, for application to a surface (e.g., skin, apparel, furniture, personal accessories, plastic products, food containers, and the like), or for broadcasting by misting systems or other distribution equipment. Aerosol formulations typically include the monoterpene and a suitable propellant (as carrier). Alternatively, the monoterpene can be dissolved or dispersed in a suitable medium, such as water or a water-miscible liquid, such as n-propanol, to provide compositions for use in non-pressurized, hand-actuated spray pumps. Ideally, aerosol formulations provide a quick kill and rapid knockdown of insects.

The bioinsecticidal compositions of this invention find particular application in controlling agricultural, storage and household pests. Therefore, this invention also provides methods for controlling insect pests by exposing one or more insect pests to an effective, insect controlling amount of a monoterpene of Formula I. The efficacy of the bioinsecticidal compositions of the present invention may be monitored by determining the mortality of or damage to the insect population, i.e., by determining its adverse effect upon treated insects. This includes damage to the insects, inhibition or modulation of insect growth, inhibition of insect reproduction by slowing or arresting its proliferation, or complete destruction/death of the pest, all of which are encompassed by the term “controlling”.

The term “effective, insect controlling amount” is an amount of a monoterpene of the invention, or a composition containing the monoterpene, that has an adverse effect on at least 25% of the insects treated, more preferably at least 50%, most preferably at least 70% or greater. Preferably, an “effective, insect controlling amount” is an amount of the monoterpene of the invention, or a composition containing the monoterpene, where 25% or greater mortality against insects is achieved, preferably 50% or greater, more preferably 70% or greater mortality. Accordingly, the amount of monoterpene used in the methods of the invention, meets the mortality criteria above, and preferably has minimal or no adverse effect on ornamental and agricultural plants (such as phytotoxicity), wildlife and humans that may come into contact with the monoterpene.

The compositions and methods described herein can be used to treat insect infestations in crop loci, storage areas, property, and the like, and to treat animals and humans exposed to, or likely to be exposed to, one or more insect. In some embodiments, the bioinsecticidal composition is used in agricultural applications, and can be non-phytotoxic or nearly so. When used in agricultural applications, bioinsecticidal composition decreases the likelihood of damage to a plant and/or a plant crop, and decreases the likelihood of adverse side effects to workers applying the bioinsecticidal composition, or to animals, fish or fowl which ingest the tissues or parts of treated plants. The methods of use of the bioinsecticidal composition of the invention will depend at least in part upon the insect to be treated and its feeding habits, as well as breeding and nesting habits. While minor dosage rates of the bioinsecticidal composition will have an adverse effect on insects, adequate control usually involves the application of a sufficient amount to either eliminate the insects entirely or significantly deter their growth and/or rate of proliferation. Dosage rates required to accomplish these effects, of course, vary depending on the target insect, size, and maturity, i.e., stage of growth. More mature pests may be more resistant to insecticides and require higher dosage rates for a comparable level of control. Dose response experiments using different dilutions (for example, about 1:5, 1:10, and 1:20) of the bioinsecticidal composition of the present invention on target insect and on plants are performed to determine the optimal concentration of the monoterpene that shows insecticidal activity without phytotoxicity or dermal sensitivity.

The compositions can also be applied to cargo holds, food containers, and storage areas, for example, by fumigation, to control insect pests. Formulae described herein are capable of being organically certified, and, when the compositions are intended for application to food containers, it is preferable that such compositions are applied. The compositions can be used to protect stored products such as grains, fruits, nuts, spices or tobacco, whether whole, milled or compounded into products, from moth, beetle, mite or grain weevil attack. Also protected are stored animal products such as skins, hair, wool or feathers in natural or converted form (e.g., as carpets or textiles) from moth or beetle attack as well as stored meat, fish or grains from beetle, mite or fly attack. In these embodiments, the naturally-occurring and safe nature of the active agents is particularly relevant.

When used as a fumigant, the bioinsecticidal composition may be used on soil, plants or structures as an aqueous solution or dispersion applied via shank injection or drip irrigation, aerosol or mist. For structural fumigation the bioinsecticidal composition may be heated to a gas before introduction within a building, chamber, vehicle or other space or structure. The space or structure is preferably sealed with a tarpaulin, fumigant tape or gas impermeable sheeting. Stacked commodities may also be treated by draping the commodities with a gas-impermeable tarp or sheet that can be sealed to an impermeable surface (such as a concrete floor) using, for example, sand-filled tubes.

Suitable means of applying the bioinsecticidal composition to growing crops include as foliar sprays (for example as an in-furrow spray), fogs or foams. Suitable means of applying the compositions to soil or roots include liquid drenches, smokes or foams. When an insect is soil-borne, the composition is distributed evenly over the area to be treated (i.e., for example broadcast or band treatment). Suitable means of applying the compositions to crop seeds include application as seed dressings, e.g., by liquid slurries. The bioinsecticidal composition can be applied to plants or areas under cultivation in the form of droplets, drop-like areas or thin, defined layers by using conventional devices. Fruit-bearing trees or vines can advantageously be treated by applying the bioinsecticidal composition using dosing dispensers, pipettes or syringes, brushing devises, or surface nozzles to distribute the compositions over a substantial area. Suitable means of applying the bioinsecticidal composition to the environment in general or to specific locations where insects may lurk, including stored products, timber, household goods, or domestic or industrial premises, include sprays, fogs, dusts, smokes, or lacquers.

The bioinsecticidal compositions can be used to control insects that are injurious to, or spread or act as vectors of diseases in domestic animals. Suitable means of applying the bioinsecticidal compositions to animals infested by or exposed to an insect, include topical application, such as by using pour-on formulations, sprays, baths, dips, showers, jets, dusts, greases, shampoos, creams, wax smears or livestock self-treatment systems.

Methods of using the instant bioinsecticidal composition offer several advantages over existing methods of pest control. The formulations disclosed herein provide for effective control of a variety of insect pests. As used herein, the term “insect pest” or “pest” refers to an insect that negatively affect plants or animals by colonizing, attacking or infecting them. This includes insects that spread disease and/or damage the host and/or compete for host nutrients. In addition, plant pests are insects known to associate with plants and which, as a result of that association, cause a detrimental effect on the plant's health and vigor.

In general, the bioinsecticidal composition of the present invention is useful for control of insects such as fleas, mosquitoes, bees, wasps, cockroaches, termites, houseflies, fruit flies, whiteflies, leafhoppers, cabbage looper, ants, Thrips, aphids, spider mites, beetles and the like. In certain embodiments, the bioinsecticidal composition and method of this invention are used to control one or more insects including, but not limited to, Examples of pest species which may be controlled include: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (Thrips), Thrips spp. (Thrips) such as T. simplex and T. palmi, Megalurothrips usitatus (Thrips), Leptinotarsa decemlineata (Colorado potato beetle), Tribolium castaneum (red flour beetle), Haptoncus picinus, Anthonomus grandis (boll weevil), Aonidiella spp. (scale insects), Trialeurodes spp. (white flies), Bemisia tabaci (white fly), Ostrinia nubilalis, (European corn borer), Spodoptera littoralis (cotton leafworm), Heliothis virescens (tobacco budworm), Helicoverpa amigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora(citrus rust mite), Polyphagotarsonemus latus (broad mite), Brevipalpus spp. (flat mites), Boophilus microplus (cattle tick), Dermacentor variabilis (American dog tick), Ctenocephalides felis (cat flea), Liriomyza spp. (leafminer), Musca domestica (housefly), Bactrocera cucuribitae (melon fly), Drosophila melanogaster (fruit fly), Aedes aegypti (mosquito), Anopheles spp. (mosquitoes), Culex spp. (mosquitoes), Lucillia spp. (blowflies), Blattella germanica (cockroach), Blattella lateralis (cockroach), Periplaneta americana (cockroach), Blatta orientalis (cockroach), termites of the Mastotermitidae (for example Mastotermes spp.), the Kalotermitidae (for example Neoterines spp.), the Rhinotermitidae (for example Coptotermes formosanus, Reticulitermes flavipes, R. speratu, R. virginicus, R. hesperus, and R. santonensis) and the Termitidae (for example Globitermes sulphureus), Solenopsis geminata (fire ant), Monomoriumn pharaonis (pharaoh's ant), Damalinia spp. and Linognathus spp. (biting and sucking lice).

The preferred bioinsecticidal compositions of the present invention have a lethal effect on pest targets. Unlike the bulk of currently available insecticides on the market, the preferred bioinsecticidal compositions have an active ingredient that is substantially non-toxic to man, domestic animals, and honeybees and has minimal adverse effects on wildlife and the environment. In this respect, the bioinsecticidal compositions of this invention are advantageous in that the bioinsecticidal compositions control insects without introducing a notable amount of harm to the surrounding environment of which the provided bioinsecticidal compositions are being used. Accordingly, the bioinsecticidal compositions can be used to treat plant pests on food crops up to and immediately before the harvesting period, a practice that generally is avoided when using conventional methods of pest control. The compositions also can be used to control the growth of pest organisms on harvested crops. Thus, the instant bioinsecticidal compositions can be incorporated into an integrated pest management (IPM) program.

The bioinsecticidal compositions of the invention have insecticidal activity against one or more insects. However, it is understood that certain bioinsecticidal compositions may be more effective on some insects than others, and may even be ineffective against some insects. In this respect, certain embodiments of this invention provide particular bioinsecticidal compositions and methods for controlling particular insect pests. In some embodiments, the bioinsecticidal composition includes (+)/(−)-pulegone and is used in a method for controlling Thrips, fruit fly of the genus Drosophila, and/or white flies. In further embodiments, the bioinsecticidal composition is a fumigant containing (+)/(−)-pulegone, which is used in a method for controlling Thrips, flour beetles and/or fruit flies. In certain embodiments, the bioinsecticidal composition includes (+)/(−)-pulegone and is used in a method for controlling Thrips of the genus Megalurothrips (e.g., M. basisetae, M. distalis, M. equaletae, M. flaviflagellus, M. formosae, M. guizhouensis, M. Haopingensis, M. mucunae, M. peculiaris, M. sinensis, M. sjostedti, M. typicus and M. usitatus). In yet another embodiment, the bioinsecticidal composition includes (+)/(−)-pulegone and is used in a method for controlling spotted wing fruit flies of the genus Drosophila. In yet further embodiment, the bioinsecticidal composition includes (+)/(−)-pulegone and is used in a method for controlling beetles, in particular flour and sap beetles, of the genera Tribolium (e.g., T. castaneum and T. confusum) and Haptoncus (e.g., H. picinus and H. luteolus). In some embodiments, the bioinsecticidal composition includes (+)/(−)-pulegone in combination with piperonyl butoxide and is used in a method for controlling Thrips, e.g., of the genus Megalurothrips.

In other embodiments, the bioinsecticidal composition is a fumigant containing carvacrol and is used in a method for controlling mosquitoes. In certain embodiments, the bioinsecticidal composition is a fumigant containing carvacrol and is used in a method for controlling mosquitoes of the genus Aedes (e.g., A. aegypti or A. albopictus).

In yet other embodiments, the bioinsecticidal composition includes trans-anethole and is used in a method for controlling rusty red cockroaches (Blatta lateralis).

In still other embodiments, the bioinsecticidal composition includes estragole and is used in a method for controlling mosquitoes. In certain embodiments, the bioinsecticidal composition is a fumigant containing estragole and is used in a method for controlling mosquitoes, e.g., mosquitoes of the genus Aedes (e.g., A. aegypti or A. albopictus).

According to other embodiments, the bioinsecticidal composition includes linalool and is used in a method for controlling Thrips and/or leafhoppers. In further embodiments, the bioinsecticidal composition is a fumigant containing linalool, which is used in a method for controlling Thrips and/or leafhoppers. In certain embodiments, the bioinsecticidal composition includes linalool and is used in a method for controlling Thrips of the genus Megalurothrips (e.g., M. basisetae, M. distalis, M. equaletae, M. flaviflagellus, M. formosae, M. guizhouensis, M. Haopingensis, M. mucunae, M. peculiaris, M. sinensis, M. sjostedti, M. typicus and M. usitatus). In yet another embodiment, the bioinsecticidal composition includes linalool and is used in a method for controlling leafhoppers of the genus Cicadella (e.g., C. viridi, C. lasiocarpae, C. longivittata, C. lunulata and C. transversa).

The following non-limiting examples are provided to further illustrate the present invention.

### EXAMPLE 1: INSECTICIDAL ACTIVITY OF MONOTERPENES

Materials. Monoterpenes included (+)-pulegone (95% purity), (−)-pulegone (98%), trans-anethole (98%), estragole (98%), 1,8-cineole (98%), carvacrol (95%), eugenol methyl ether (98%), linalool (97%), (−)-linalool (95%), (+)-limonene (96%), (−)-limonene (96%), ethyl formate (98%) and myrcene (90%) (Table 1). These chemicals were purchased from Fisher Scientific (Pittsburgh, PA) or Sigma-Aldrich (St. Louis, MO). 2,2-Dichlorovinyl dimethyl phosphate (DDVP, or dichlorvos) was commercially purchased.

TABLE 1

| Monoterpene | Structure | Vp (Pa)/T (° C.) |
|---|---|---|
| (+)-Pulegone | 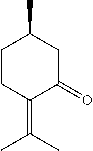 | 16.3/25 |
| (−)-Pulegone | 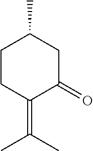 | 16.3/25 |
| Estragole | 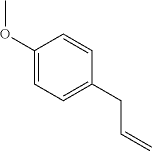 | 27.93/25 |
| trans-Anethole | 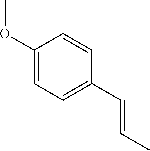 | 5.45/21 |
| Linalool | 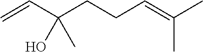 | 21.28/22-25 |
| Carvacrol | 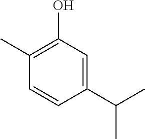 | 3.99/25 |
| Eugenol Methyl Ether | 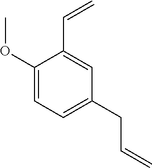 | 1.60/25 |
| 1,8-Cineole | 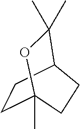 | 253.31/25 |
| (+)-Limonene | 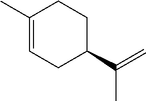 | 263.97/25 |
| (−)-Limonene | 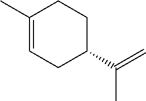 | 206.65/25 |
| Myrcene | 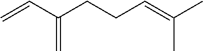 | 278.64/25 |
| (−)-Linalool | 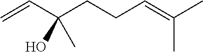 | 21.20/23.5 |

Thrips. The Thrips Megalurothrips usitatus (Bagnall, 1913) (Thysanoptera: Thripidae) were used in preliminary screening tests and LC₅₀ determinations. Adult Thrips were used in both cases, but differed in crops where they were collected and collection areas and rearing.

The colony of Thrips used in preliminary tests was maintained in the laboratory to provide adults for the mortality experiment to screen monoterpenes. Adult Thrips were obtained from hyacinth bean plants (Lablab purpureus) grown on the University of Hawaii at Manoa campus to initiate the colony. The Thrips used to determine 24-hour LC₅₀ were also M. usitatus. The adult Thrips were obtained from a cowpea (Vigna unguiculata) field. The adult Thrips were placed inside a ventilated 500-mL glass spawn bottle with cowpea pods and maintained at 25±1° C. and a photoperiod of 12:12 hours (Light:Day). The colony of adult Thrips was artificially reared for 19 generations and used for fumigation tests. This process was repeated for colony maintenance and future collection of adults.

Spider Mites. Carmine spider mites, Tetranychus cinnabarinus (Boisduval, 1867) (Acari: Tetranychidae) were collected from an eggplant field. The Tetranychus mites that were healthy and had no previous exposure to pesticides were used for fumigation tests.

Melon Fly. Bactrocera cucuribitae (Coquillet, 1849) (Diptera: Tephritidae), melon fly, were reared in accordance with known methods (Follett, et al. (2013) J. Econ. Entomol. 106(5):2020-2026). The flies were those that emerged for 3 days and were in a sensitive stage.

Nitidulidae. Haptoncus picinus (Grouvelle, 1906) adults were collected from an eggplant field. The insects were healthy and had no previous exposure to pesticides.

Red Flour Beetle. Tribolium castaneum (Herbst, 1797) (Insecta, Coleoptera), a storage insect commonly called red flour beetle, was reared with wheat bran.

House Fly. Pupae of Musca domestica (Linnaeus, 1758) (Diptera: Muscidae) were purchased from a commercial source. Three-day-old adults (after emergence) were used for fumigation tests.

Cockroach. Larvae of rusty red cockroaches Blatta lateralis (Walker, 1868) (Blattaria: Blattidae) were purchased from a commercial source). Second instar nymphs (0.9-1.3 cm) that were reared with peanut oil on a piece of paper for one week were used in fumigation tests.

Mosquito. Yellow fever mosquitos Aedes aegypti (Linnaeus, 1762) (Diptera: Culicidae) were reared with 8% glucose solution. Three-day-old mosquito adults were used in fumigation tests.

Insect Egg Parasitic Wasp (Natural Enemy). Two species of insect natural enemy parasitoids were analyzed including Trichogramma chilonis (Ishii, 1941) (Hymenoptera: Trichogrammatidae) and Anastatus japonicus (Ashmead, 1904) (Hymenoptera: Eupelmidae). Both species were purchased from a commercial source. One- to two-day-old adults (after eclosion) were used for fumigation tests.

Preliminary Screening Tests. Monoterpenes applied at varying concentrations on pieces of moist tissue paper were tested against thirty, 5-day-old adult Megalurothrips usitatus in 1-L (1000 cm³) flasks for 24 hours of fumigation. No monoterpene was the control. Acetone and chloroform were the solvent controls and ethyl formate was used as a positive fumigant control. Each treatment was replicated four times. Mortality data were used to preliminarily select monoterpenes for further studies. The preliminary tests indicated that six out of 11 monoterpenes were active and acted fast.

Median Lethal Concentration Tests. Median lethal concentrations (LC₅₀) of (+)-pulegone, estragole, trans-anethole, linalool, carvacrol, and eugenol methyl ether were determined according to the pesticides guidelines for laboratory bioactivity tests and the laboratory efficacy test methods and criteria of public health insecticides for pesticide registration. The species tested included Thrips (M. usitatus), spider mite (T. cinnabarinus), melon fly (B. cucuribitae), cockroach (B. lateralis), housefly (M. domestica), mosquito (A. aegypti), parasitic wasp (T. chilonis) and fruit fly (Drosophila melanogaster). After being exposed to the test chemicals for one hour, adult Thrips, spider mites, and roaches were transferred to another flask. In addition to fresh water, adult Thrips, spider mites, and roaches were then respectively fed with cowpea, fresh blade of eggplant, and peanut oil via filter. Mortality of Thrips was observed in 24 hours. Mortality of melon fly was observed after three hours of exposure. Mortality of fruit fly was observed after 280 minutes. After adult housefly and melon fly were exposed for one hour and mosquitoes were exposed for 30 minutes (Manimaran, et al. (2012) Adv. Biosci. Biotechnol. 3:855-862), they were fed with fresh water and food (milk powder for housefly; 1:1 yeast powder and sugar mix for melon fly; water alone for mosquito) in the same flask. The mortality was observed in 24 hours. Mortality of the parasitic wasps was observed after 15 minutes of exposure.

Median Lethal Time (LT₅₀) and Median Knockdown Concentration (KC₅₀) Tests. Five species of adult insects or natural enemies were tested for LT₅₀ values including melon fly (B. cucuribitae), red flour beetle (T. castaneum), Nitidulidae beetle (H. picinus), parasitic wasp (A. japonicus) and housefly (M. domestica). For each treatment and control, 20 insects at the developmental stages described above were placed individually without food in a 1-L wide-mouth glass bottle (height 19.5 cm, bottom diameter 10.5 cm, mouth i.d. 5.5 cm) containing pieces of tissue paper. The bottle was incubated at 25±1° C. under a 12:12-hour light:dark regime. Five different concentrations of the test chemicals were placed on pieces of cellulose-based qualitative filter paper. Each of the filter papers was placed in a bottle to have 5 appropriate concentrations in serial dilutions. DDVP was the positive control, and no chemical treatments were the negative control. All treatments and controls were in triplicate. Mortality was observed periodically in a 10-30 minute interval for 2 days or until all insects died. The death was defined as no movement when the insects were touched.

LC₅₀ Determinations for a Mixture of Monoterpenes and Linalool Mixed in Corn Oil. To investigate the potential use of the monoterpenes in a mixture, two and three monoterpenes were mixed and then tested for LC₅₀ values against the Thrips, M. usitatus.

Fumigation Toxicity. To confirm the fumigation toxicity, laboratory bioassays were conducted to evaluate the toxicity of linalool mixed in edible peanut oil. Larvae of M. usitatus Thrips were maintained in a rearing bottle and fed with cowpea at 25±1° C. under a 12:12-hour light:dark regime. Larvae in the second instar were used in this test. The Thrips were placed individually without food in an RNA purification tube above the filter and 1 mL of linalool/corn oil mixture was placed at the bottom of the tube. Thirty insects were used in each treatment in triplicate. Linalool was in 19.2-, 13.7-, 9.8-, 7.0- and 5.0-fold dilutions with edible peanut oil.

Field Tests. Linalool exhibited moderate laboratory toxicity among all tested monoterpenes. Therefore, it was determined whether this compound could control Thrips in the field. Linalool was in 20-, 10- and 5.0-fold dilutions with edible peanut oil. The positive control was spinetoram (Dow AgroSciences) in 3000-fold dilution.

The field experimental plots were 15 m² in size, in triplicate. A designated sprayer (Dia spray No. 3530, Japan Furlpla Co., Japan) was used to spray the solvent only negative control in this experiment. Grub density was calculated at every plot prior to application. During the experiments, the field was also infested with leafhoppers, so that the control efficacy of leafhoppers was also assessed. The number of adult Thrips and leafhoppers was assessed in the treatment and control areas at 1, 3, 5, 7, 14 and 21 days after application. The decline of the adult Thrips and leafhoppers was calculated to assess the control efficacy of linalool.

Statistical Analysis. Mortality percentage was calculated based upon the total number of insects died from the monoterpene treatment. Mortality was transformed to logit (L=In[(m+0.5)/(100.5−m)], where m is mortality percentage. Regression analysis of mortality records included only the final record of zero mortality and the first record of 100% morality. All other occurrences of 0% and 100% in the time data matrix were omitted.

The co-toxicity coefficient (Sarup, et al. (1980) J. Entomol. Res. 4:1-14) and synergistic factor (Kalayanasundaram & Das (1985) Ind. J. Med. Res. 82:19-21) for the monoterpene mixtures were calculated (Chenniappan & Ayyadurai (2012) Parasitol. Res. 110:381-388) after LC₅₀ and LC₉₀ for each mixture were determined.

Co-toxicity coefficient (CTC)=Co-toxicity of Compound A (alone)/toxicity of Compound A with B×100.

Synergistic factor (SF)=toxicity of Compound A (alone)/toxicity of Compound A with B. A value of SF>1 indicates synergism, while SF<1 indicates antagonism.

The LC₅₀ values were calculated with GraphPad Prism version 6.05 (GraphPad Software, La Jolla, CA, USA). The concentration-mortality data were used to estimate LC₅₀ values and associated 95% confidence limits for each treatment.

Preliminary Screening Tests. Numerous monoterpenes were screened for potency against flower Thrips. Four monoterpenes, including 1,8-cineole, (+)-limonene, (−)-limonene and myrcene, were not active against flower Thrips and thus were not further analyzed. Notably, both linalool and (−)-linalool had similar toxicity to flower Thrips. In addition, ethyl formate, acetone and chloroform were tested for their potency against flower Thrips. No mortality was observed at a concentration of 40 nL/cm³ for acetone and chloroform (approximately 32 μg/cm³ for acetone and 60 μg/cm³ chloroform), which was consistent with previous studies (Chang, et al. (2009) J. Econ. Entomol. 102(1):203-209). The LC₅₀ of ethyl formate was greater than 9.2 μg/cm³. These data indicated that (+)-pulegone, trans-anethole, estragole, 1,8-cineole, carvacrol and eugenol methyl ether exhibit insecticidal activity.

Toxicity of Monoterpenes to Agricultural Pests. The legume Thrips, M. usitatus, is one of the most serious insect pests of leguminous plants including cowpea in tropical Africa (Ekesi, et al. (1998) J. Afr. Crop. Sci. 6:49-59; Karungi, et al. (2000) Crop. Prot. 19:343-347). The repellency of 24 plant extracts was evaluated against adult female Thrips of M. sjostedti in the laboratory, and extracts from Piper nigrum, Cinnamomum zeylanicum and Cinnamomum cassia were identified as strong repellents. Another report studied the fumigation toxicity of basil oil compounds and related compounds to Thrips palmi and Orius strigicollis. This study indicated that linalool was the most toxic fumigant of adult T. palmi (LC₅₀ 5.5 μg/cm³), and was 15.2-fold more effective than dichlorvos (83.7 μg/cm³). Strong fumigation toxicity was also observed for (−)-pulegone (9.5 μg/cm³), (±)-camphor (9.7 μg/cm³) and 1,8-cineole (16.7 μg/cm³) (Kim, et al. (2015) Pest Manag. Sci. 71:1292-1296).

Tetranychus is one of the most economically important genera of mites, due to its high potential to destroy agriculture. It contains over 140 species, the most significant of which is Tetranychus cinnabarinus. Solanum sarrachoides essential oils and their monoterpene constituents have been shown to play a role in regulating oviposition in the tomato spider mite Tetranychus evansi (Lucy, et al. (2013) Industr. Crops Prod. 46:73-79).

Melon fly is an important economic and quarantine pest of tropical fruits and one of the most radiation-tolerant tephritid fruit flies known (Follett & Armstrong (2004) J. Econ. Entomol. 97:1254-1262; Follett, et al. (2011) J. Econ. Entomol. 104:1509-1513).

LC₅₀ (Table 2), LC₉₀ (Table 3), and dose-response slopes (Table 4) of six monoterpenes and DDVP for these three agricultural pest species (M. usitatus, T. cinnabarinus, and B. cucuribitae) were determined.

TABLE 2

| | | |
|---|---|---|
| | LC₅₀ (fiducial limits) | Chi- |
| Compound | (μg/cm³) | square |

Megalurothrips usitatus (Bagrall) (thrips)

| | | | |
|---|---|---|---|
| DDVP 80% | 0.68 | (0.43-1.43) | 3.91 |
| (+)-Pulegone | 0.20 | (0.11-0.27) | 0.352 |
| Estragole | 0.24 | (0.09-0.38) | 1.67 |
| trans-Anethole | 0.36 | (0.00-1.86) | 0.037 |
| Linalool | 2.50 | (1.72-3.36) | 0.202 |

| | |
|---|---|
| Carvacrol | >19.2 |
| Eugenol methyl ether | >19.2 |

Tetranychus cinnabarinus (Boisduval) (spider mites)

| | | | |
|---|---|---|---|
| DDVP 80% | 0.43 | (0.33-0.58) | 1.81 |
| (+)-Pulegone | 2.52 | (1.31-5.23) | 0.064 |
| Estragole | 3.28 | (2.03-5.89) | 5.23 |
| trans-Anethole | 5.73 | (2.77-19.8) | 4.002 |
| Linalool | 550 | (46.3-5940) | 0.103 |
| Carvacrol | 37.5 | (14.1-770) | 0.708 |

| | |
|---|---|
| Eugenol methyl ether | >48.6 |

Bactrocera cucuribitae (Coquillett) (melon fly)

| | | | |
|---|---|---|---|
| DDVP 80% | 0.0014 | (—) | 0.005 |
| (+)-Pulegone | 112 | (65.4-430) | 1.34 |
| Estragole | 483 | (212-261) | 0.050 |
| trans-Anethole | 417 | (217-18700) | 1.15 |

| | | |
|---|---|---|
| Linalool | >243 | >243 |
| Carvacrol | >243 | >243 |
| Eugenol methyl ether | >243 | >243 |

(—), Fiducial limits were larger than 1000-fold.

TABLE 3

| | |
|---|---|
| Compound | LC₉₀ (fiducial limits) (μg/cm³) |

Megalurothrips usitatus (Bagrall) (thrips)

| | | |
|---|---|---|
| DDVP 80% | 1.85 | (1.36-31.6) |
| (+)-Pulegone | 0.67 | (0.46-3.15) |
| Estragole | 1.29 | (0.69-7.48) |
| trans-Anethole | 8.53 | (3.98-1850) |
| Linalool | 6.4 | (4.51-11.7) |

| | |
|---|---|
| Carvacrol | >19.2 |
| Eugenol methyl ether | >19.2 |

Tetranychus cinnabarinus (Boisduval) (spider mites)

| | | |
|---|---|---|
| DDVP 80% | 0.80 | (0.59-1.58) |
| (+)-Pulegone | 40.8 | (14.5-415) |
| Estragole | 21.0 | (10.1-86.6) |
| trans-Anethole | 144 | (33.1-8588) |
| Linalool | 4330 | (—) |
| Carvacrol | 510 | (—) |

| | |
|---|---|
| Eugenol methyl ether | >48.6 |

Bactrocera cucuribitae (Coquillett) (melon fly)

| | | |
|---|---|---|
| DDVP 80% | 0.0014 | (0.0014-0.0028) |
| (+)-Pulegone | 657 | (—) |
| Estragole | 953 | (—) |
| trans-Anethole | 5130 | (—) |

| | |
|---|---|
| Linalool | >243 |
| Carvacrol | >243 |
| Eugenol methyl ether | >243 |

(—), Fiducial limits were larger than 1000-fold.

TABLE 4

| | | |
|---|---|---|
| | Regression | |
| Compound | equation | Slope ± SE |

Megalurothrips usitatus (Bagrail) (thrips)

| | | |
|---|---|---|
| DDVP 80% | 0.976x + 0.94 | 3.0 ± 0.5 |
| ( + )-Pulegone | 2.3x + 1.61 | 2.3 ± 0.5 |
| Estragole | 1.71x + 1.07 | 1.7 ± 0.5 |
| trans-Anethole | 0.942x + 0.40 | 0.94 ± 0.39 |
| Linalool | 3.11x − 1.43 | 3.1 ± 0.6 |
| Carvacrol | — | — |
| Eugenol methyl ether | — | — |

Tetranychus cinnabarinus (Boisduval) (spider mites)

| | | |
|---|---|---|
| DDVP 80% | 4.82x + 2.50 | 4.8 ± 1.2 |
| (+)-Pulegone | 1.06x + 0.46 | 1.1 ± 0.2 |
| Estragole | 1.59x − 0.85 | 1.6 ± 0.3 |
| trans-Anethole | 0.193x + 0.69 | 0.91 ± 0.23 |
| Linalool | 0.442x − 1.24 | 0.44 ± 0.22 |
| Carvacrol | 1.14x + 1.83 | 1.1 ± 0.4 |
| Eugenol methyl ether | — | — |

Bactrocera cucuribitae (Coquillett) (melon fly)

| | | |
|---|---|---|
| DDVP 80% | 6.90 + 21.9 | 6.9 ± 2.3 |
| (+)-Pulegone | 1.70x − 3.56 | 1.7 ± 0.5 |
| Estragole | 4.36x − 11.8 | 4.4 ± 1.8 |
| trans-Anethole | 1.18x − 3.09 | 1.1 ± 0.4 |
| Linalool | 2.17x − 9.03 | 2.2 ± 2.3 |
| Carvacrol | 2.35x − 7.89 | 2.3 ± 2.8 |
| Eugenol methyl ether | 3.93x − 11.0 | 3.9 ± 0.9 |

In general, the six monoterpenes varied from being inactive to very toxic to the test organisms. (+)-Pulegone, for example, was very toxic to the Thrips, whereas carvacrol and eugenol methyl ether were generally not toxic to any of the test organisms. Specifically, (+)-pulegone, estragole and trans-anethole were highly toxic to Thrips with LC₅₀ values of 0.196, 0.241 and 0.356 μg/cm³, respectively (Table 2). The activities of (+)-pulegone, estragole and trans-anethole were 3.5-, 2.8- and 1.9-fold greater (smaller LC₅₀ values) than that of the positive control, DDVP.

The LC₅₀ of all six compounds for spider mites, T. cinnabarinus, were at least 5.8-fold greater than that of DDVP (Table 2). Among the six monoterpenes, (+)-pulegone was the most toxic to T. cinnabarinus with an LC₅₀ of 2.52 μg/cm³.

The monoterpenes tested were not very active against B. cucuribitae (Tables 2 and 3). Among the six terpenoids, (+)-pulegone had the lowest LC₅₀ (112 μg/cm³) and linalool was inactive against B. cucuribitae.

To assess the impact of exposure time on efficacy, LC₅₀ and LC₉₀ values of (+)-pulegone and linalool were determined against Thrips (M. usitatus (Bagrall)) after a 24-hour exposure to the compounds. The results of this analysis are presented in Table 5.

TABLE 5

| | LC₅₀ (fiducial limits) | Chi- | LC₉₀ (fiducial limits) |
|---|---|---|---|
| Compound | (μg/cm³) | square | (μg/cm³) |
| (+)-Pulegone | 0.032 × 10⁻³ | 8.56 | 0.121 × 10⁻³ |
| | (0.025-0.04 × 10⁻³) | | (0.086-0.199 × 10⁻³) |
| Linalool | 0.24 × 10⁻³ | 34.07 | 0.60 × 10⁻³ |
| | (0.20-0.29 × 10⁻³) | | (0.46-0.94 × 10⁻³) |

Activity of Monoterpenes Against Household Insect Pests. M. domestica is a major domestic pest that causes irritation, spoils food, and acts as a vector for more than 100 pathogens of medical and veterinary significance (Kumar, et al. (2012) Parasitol. Res. 110:1929-1936). In spite of this, the control aspect of the common housefly, M. domestica, is often neglected (Kumar, et al. (2013) Parasitol. Res. 112:69-76). It has been shown that citral and 1,8-cineole are highly active against housefly (Kumar, et al. (2013) Parasitol. Res. 112:69-76), and that Citrus sinensis essential oil is effective in a fumigation assay (Rossi & Palacios (2013) Acta Tropica 127(1):33-37). Further, efficacy tests against housefly adults revealed high repellent activities by menthol (96%) and menthone (83%) (Kumar, et al. (2014) Ecotoxicol. Environ. Safety 100:1-6).

B. lateralis is an important insect pest in urban environments. Cockroaches not only spoil food, but also transfer pathogens and cause allergic reactions and psychological distress. Notably, larvae of rusty red cockroach, B. lateralis, are prevalent in hotels and food outlets.

A. aegypti is known to mediate that spread of dengue as well as many other diseases. As a consequence, controlling the spread of dengue requires that mosquitoes be directly targeted (Konishi (2011) Trop. Med. Health 39(4 Suppl.):63-71; Gupta & Reddy (2013) Parasitol. Res. 112(4):1367-78). Essential oil compounds from 269 plant species have been tested for their larvicidal activity against mosquito larvae, including pulegone, linalool, trans-anethole and carvacrol (Dias, et al. (2014) Parasitol. Res. 113:565-592). Preliminary screening of 25 essential oils against the mosquito Culex quinquefasciatus indicated that mentha oil and calamus oil were the most promising larvicides and orange oil had potent knockdown activity (Manimaran, et al. (2012) Adv. Biosci. Biotechnol. 3:855-862).

Drosophila melanogaster is the common fruit fly found in homes with ripe, rotting, or decayed fruit and produce. Aside from being a nuisance, fruit flies have the potential to contaminate food with bacteria and other pathogens.

LC₅₀ (Table 6), LC₉₀ (Table 7), and dose-response slopes (Table 8) of monoterpenes and DDVP for these four household pest species (M. domestica, B. lateralis, A. aegypti and D. melanogaster) were determined.

TABLE 6

| | | |
|---|---|---|
| | LC₅₀ (fiducial limits) | Chi- |
| Compound | (μg/cm³) | square |

Musca domestica (Linnaeus) (housefly)

| | | | |
|---|---|---|---|
| DDVP 80% | 0.21 | (0.00-0.29) | 3.59 |
| (+)-Pulegone | 7.38 | (5.14-10.3) | 0.118 |
| Estragole | 5.89 | (0.00-9.36) | 0.053 |
| trans-Anethole | 83.0 | (57.3-158) | 1.04 |
| Linalool | 30.6 | (17.5-65.5) | 5.07 |

| | | |
|---|---|---|
| Carvacrol | >243 | 6.04 |
| Eugenol methyl ether | >243 | 3.61 |

Blatta lateralis (Walker) (cockroach)

| | | | |
|---|---|---|---|
| DDVP 80% | 4.99 | (3.42-14.6) | 0.015 |
| (+)-Pulegone | 15.0 | (6.8-47.7) | 1.23 |
| Estragole | 24.1 | (14.5-37.6) | 0.738 |
| trans-Anethole | 4.25 | (0.09-9.19) | 3.02 |
| Linalool | 345 | (—) | 0.642 |
| Carvacrol | 84.5 | (62.9-103) | 0.829 |

| | | |
|---|---|---|
| Eugenol methyl ether | >243 | 0.705 |

Aedes aegypti (Linnaeus) (mosquito)

| DDVP 80% | 0.0014 | (0.00-0.00142) | 0.141 |
|---|---|---|---|
| (+)-Pulegone | 10.3 | (1.30-187) | 0.142 |
| Estragole | 0.25 | (0.0676-0.936) | 0.647 |
| trans-Anethole | 2.67 | (1.28-10.9) | 5.24 |
| Linalool | >243 | | 16.3 |
| Carvacrol | 0.77 | (0.19-1.88) | 1.69 |

| | | |
|---|---|---|
| Eugenol methyl ether | >243 | 0.602 |

Drosophila melanogaster (fruit fly)

| | | | |
|---|---|---|---|
| DDVP 80% | 0.001 × 10⁻³ | (0.000-0.001 × 10⁻³) | 115 |
| (+)-Pulegone | 0.043 × 10⁻³ | (0.034-0.055 × 10⁻³) | 53.3 |
| (−)-Pulegone | 0.106 × 10⁻³ | (0.087-0.144 × 10⁻³) | 20.8 |

(—), Fiducial limits were larger than 1000-fold.

TABLE 7

| | |
|---|---|
| Compound | LC₉₀ (fiducial limits) (μg/cm³) |

Musca domestica (Linnaeus) (housefly)

| | | |
|---|---|---|
| DDVP 80% | 0.53 | (0.33-3.39) |
| (+)-Pulegone | 11.9 | (9.06-13.4) |
| Estragole | 15.3 | (6.85-5530) |
| trans-Anethole | 137 | (98.2-2800) |
| Linalool | 176 | (76.4-2970) |

| | |
|---|---|
| Carvacrol | >243 |
| Eugenol methyl ether | >243 |

Blatta lateralis (Walker) (cockroach)

| | | |
|---|---|---|
| DDVP 80% | 9.51 | (6.54-26.9) |
| (+)-Pulegone | 173 | (52.4-6920) |
| Estragole | 15.3 | (9.65-5530) |
| trans-Anethole | 25.8 | (12.5-411) |
| Linalool | 1700 | (—) |
| Carvacrol | 118 | (95.7-204.0 |

| | |
|---|---|
| Eugenol methyl ether | >243 |

Aedes aegypti (Linnaeus) (mosquito)

| DDVP 80% | 0.0028 | (0.00-1.83) |
|---|---|---|
| (+)-Pulegone | 16.8 | (—) |
| Estragole | 0.91 | (0.44-8.59) |
| trans-Anethole | 10.6 | (4.36-869) |
| Linalool | >243 | |
| Carvacrol | 3.92 | (1.69-162) |

| | |
|---|---|
| Eugenol methyl ether | >243 |

Drosophila melanogaster (fruit fly)

| | | |
|---|---|---|
| DDVP 80% | 0.002 × 10⁻³ | (0.001-0.004 × 10⁻³) |
| (+)-Pulegone | 0.140 × 10⁻³ | (0.096-0.292 × 10⁻³) |
| (−)-Pulegone | 0.359 × 10⁻³ | (0.236-0.715 × 10⁻³) |

(—), Fiducial limits were larger than 1000-fold.

TABLE 8

| | | |
|---|---|---|
| | Regression | |
| Compound | equation | Slope ± SE |

Musca domestica (Linnaeus) (housefly)

| | | |
|---|---|---|
| DDVP 80% | 2.73x + 2.46 | 2.7 ± 1.1 |
| (+)-Pulegone | 6.25x − 5.62 | 6.2 ± 2.2 |
| Estragole | 3.09x − 7.43 | 3.1 ± 1.6 |
| trans-Anethole | 5.84x − 11.2 | 5.8 ± 2.5 |
| Linalool | 1.69x − 2.61 | 1.7 ± 0.5 |
| Carvacrol | 0.365x − 0.976 | 0.37 ± 0.43 |
| Eugenol methyl ether | 0.784x − 2.56 | 0.78 ± 0.70 |

Blatta lateralis (Walker) (cockroach)

| | | |
|---|---|---|
| DDVP 80% | 4.63x − 2.53 | 4.6 ± 1.4 |
| (+)-Pulegone | 1.29x − 1.46 | 1.2 ± 0.3 |
| Estragole | 3.57x − 4.97 | 3.6 ± 1.0 |
| trans-Anethole | 1.64x − 1.05 | 1.6 ± 0.6 |
| Linalool | 1.86x − 4.82 | 1.9 ± 0.8 |
| Carvacrol | 8.81x − 17.2 | 8.8 ± 2.8 |
| Eugenol methyl ether | 1.81x − 5.43 | 1.8 ± 1.4 |

Aedes aegypti (Linnaeus) (mosquito)

| | | |
|---|---|---|
| DDVP 80% | 0.861x − 2.29 | 0.86 ± 0.42 |
| (+)-Pulegone | 5.89x − 6.11 | 5.9 ± 2.9 |
| Estragole | 2.33x + 1.38 | 2.3 ± 0.8 |
| trans-Anethole | 2.16x − 0.945 | 2.2 ± 0.8 |
| Linalool | 1.86x − 4.82 | 1.9 ± 0.8 |
| Carvacrol | 1.81x − 0.157 | 1.8 ± 0.7 |
| Eugenol methyl ether | 2.15x − 7.99 | 3.4 ± 2.2 |

Drosophila melanogaster (fruit fly)

| | | |
|---|---|---|
| DDVP 80% | 2.56x + 8.49 | 8.49 ± 0.69 |
| (+)-Pulegone | 2.50x + 3.41 | 3.41 ± 0.36 |
| (−)-Pulegone | 2.42x + 2.36 | 2.36 ± 0.41 |

The LC₅₀ of (+)-pulegone, trans-anethole, estragole, 1,8-cineole, carvacrol and eugenol methyl ether against house flies, roaches and mosquitoes were higher than those of DDVP (Table 6). These monoterpenes were at least 28 times less toxic to M. domestica than DDVP (Table 6). Estragole was the most active compound against A. aegypti (LC₅₀, 0.25 μg/cm³) and M. domestica (LC₅₀, 5.89 μg/cm³); linalool was moderate; and eugenol methyl ether was not active against the three household insects (Table 6). Trans-anethole was potent against rusty red cockroaches with an average LC₅₀ value of 4.25 μg/cm³, i.e., an amount which was slightly more toxic than of DDVP (4.99 μg/cm³) (Table 6). Moreover, this analysis indicated that the (+) isomer of pulegone is significantly more toxic to fruit fly than the (−) isomer.

Monoterpenes as Fumigants. Linalool was used as a representative chemical to confirm that the monoterpenes act as fumigants rather than contact poisons. Bioassays were conducted in which Thrips, M. usitatus, were exposed to the headspace above a solution containing linalool in peanut oil. The LC₅₀ value was 4.7% for linalool mixed in peanut oil. The results indicate that linalool is indeed a fumigant to the flower Thrips.

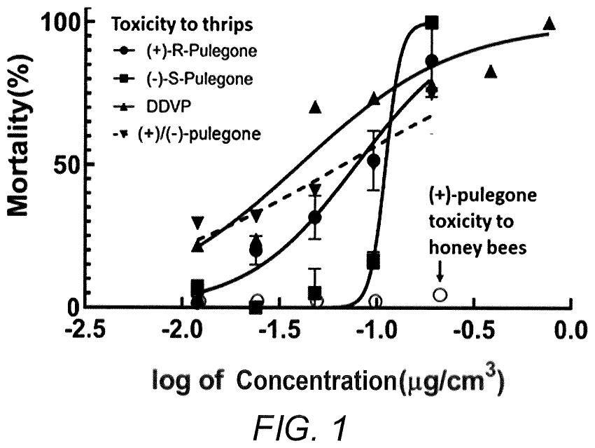

No information on essential oil (EO) was found in the literature. Therefore, the 24-hour fumigation toxicity of (+)-pulegone and (−)-pulegone to the Thrips Megalurothrips usitatus and of (+)-pulegone to the Italian honeybee Apis mellifera was evaluated. (+)-Pulegone showed little lethal toxicity to the Italian honeybee (Apis mellifera) in bioassay tests (FIG. 1). The dose-response curve was steep for pulegone (FIG. 1), confirming fast knockdown for (+)- and (−)-isomers, which also displayed high stereoselectivity. LC₅₀ values for (+)-pulegone, (−)-pulegone, racemic (+)/(−)-pulegone mixture, and DDVP (i.e., dichlorvos) against Thrips are 0.079, 0.106, 0.064 and 0.042 μg/cm³, respectively. In addition, different shapes of the dose-mortality curves of (+)- and (−)-pulegone indicate that two different action targets against Thrips, M. usitatus (FIG. 1).

Toxicity of Monoterpenes as Fumigants. Notably, the varying slopes of the dose-response curves (Tables 4 and 7) suggest different modes of action among the monoterpenes. Therefore, to determine how fast the monoterpenes act as fumigants, it was necessary to determine their LT₅₀ values for the target organisms. Table 9 shows LT₅₀ values of six test compounds and DDVP to the pest species B. cucuribitae (melon fly), T. castaneum (red flour beetle), H. picinus (Nitidulid beetle), and M. domestica (housefly).

TABLE 9

| | LT₅₀ (fiducial limits) (hour) | | | |
|---|---|---|---|---|
| | B. | T. | H. | M. |
| Compound | cucuribitae | castaneum | picinus | domestica |
| 80% DDVP | 0.89 | 2.70 | 0.89 | 0.14 |
| | (0.28-1.27) | (2.14-3.46) | (0.70-1.40) | (0.13-0.16) |
| (+)- | 0.87 | 3.47 | 0.50 | 0.33 |
| Pulegone | (0.67-1.00) | (2.50-4.41) | (0.42-0.56) | (0.25-0.39) |
| Estragole | 1.69 | 8.23 | 0.60 | 1.04 |
| | (0.49-2.22) | (5.87-10.8) | (0.48-0.72) | (0.91-1.15) |
| trans- | 2.28 | 7.97 | 1.07 | 2.01 |
| Anethole | (1.62-2350) | (7.42-8.46) | (0.85-1.34) | (1.82-2.27) |
| Linalool | 2.05 | 35.1 | 1.58 | 1.28 |
| | (1.11-2.76) | (25.6-60.6) | (1.37-1.95) | (1.04-1.70) |
| Carvacrol | 2.49 | 9.95 | 1.94 | 2.30 |
| | (2.05-2.92) | (0.002-23.4) | (1.47-7.29) | (2.01-2.86) |
| Eugenol | 2.96 | >48^{a} | 0.61 | 2.56 |
| methyl | (2.14-16.2) | | (0.35-0.80) | (2.32-3.13) |
| ether | | | | |
| Acetone | >48^{a} | >48^{a} | >48^{a} | >48^{a} |
| Chloroform | >48^{a} | >48^{a} | >48^{a} | >48^{a} |

^{a}Less than 50% mortality were observed 48 hours after exposure.

LT₅₀ Values for Agricultural Pests. Relative to the other five monoterpenes, (+)-pulegone acted at least 1.9-and 1.2-fold faster against B. cucuribitae and H. picinus, respectively (Table 9). The LT₅₀ of (+)-pulegone and DDVP were comparable to each other against B. cucuribitae. Notably, (+)-pulegone acted on H. picinus approximately twice as fast as DDVP (LT₅₀ 0.500 hour vs 0.894 hour). Fast toxicity of (+)-pulegone indicates probable action on nerve systems. The LT₅₀ of (+)-pulegone against H. picinus was approximately half of DDVP (0.500 hour vs 0.894 hour). On the basis of LC₅₀ and LT₅₀ values, (+)-pulegone was the most active compound amongst the monoterpenes tested.

LT₅₀ Values for Storage Pests. T. castaneum is a serious insect pest of stored products. LT₅₀ values of the six monoterpenes against T. castaneum were at least 1.3-fold greater than that of DDVP (Table 9). The LT₅₀ of (+)-pulegone was comparable to DDVP against T. castaneum (LT₅₀ 3.47 hours vs 2.70 hours).

LT₅₀ Values for Household Pests. Evaluation of LT₅₀ valued indicated that houseflies responded to carvacrol within 10 minutes; to (+)-pulegone, estragole, linalool and DDVP within 20 minutes; and to trans-anethole within 30 minutes. Eugenol methyl ether was not insecticidal to the housefly by 30 minutes. The LT₅₀ of (+)-pulegone to M. domestica was approximately twice of DDVP (0.331 hour vs 0.143 hour) (Table 8). Aedes aegypti responded to (+)-pulegone, estragole, trans-anethole, and carvacrol within 10 minutes, to linalool within 20 minutes, and to DDVP and eugenol methyl ether within 30 minutes (Table 9).

Knockdown Activity of Monoterpenes. In addition to the rate of killing as an assessment of toxicity, the median knockdown dose (KD₅₀) was also determined for (+)-pulegone, estragole, linalool, trans-anethole, eugenol methyl ether, and carvacrol as compared to DDVP. When tested against A. aegypti and M. domestica, the results indicate that estragole and (+)-pulegone were significantly insecticidal to houseflies (Tables 6-8 and 10).

TABLE 10

| | KC₅₀ (fiducial limits) (μg/cm³) | | |
|---|---|---|---|
| Compound | 10 Minutes | 20 Minutes | 30 Minutes |

Aedes aegypti (mosquito)

| DDVP 80% | . . . | . . . | | >0.081 | |
|---|---|---|---|---|---|
| (+)-Pulegone | 19.6(8.41-35.5) | 1.40 | (0.67-2.52) | 1.4 | (0.67-2.52) |
| Estragole | >8.1 | 2.32 | (1.06-4.44) | >8.1 | |
| trans- | >8.1 | 4.84 | (2.87-10.9) | 4.05 | (1.88-35.6) |
| Anethole | | | | | |

| | | | | |
|---|---|---|---|---|
| Linalool | . . . | >243 | 69.0 | (32.3-14800) |

| | | | | |
|---|---|---|---|---|
| Carvacrol | >243 | 6.0 | (—) | >243 |

| | | | |
|---|---|---|---|
| Eugenol | . . . | . . . | >243 |
| methyl ether | | | |

Musca domestica (housefly)

| DDVP 80% | . . . | >2.7 | >2.7 | |
|---|---|---|---|---|
| (+)-Pulegone | . . . | >243 | 12.2 | (8.97-15.0) |
| Estragole | . . . | >502 | >243 | |
| trans- | . . . | . . . | >243 | |
| Anethole | | | | |
| Linalool | . . . | >243 | 192 | (122-393) |

| | | | |
|---|---|---|---|
| Carvacrol | >7600 | >243 | >243 |
| Eugenol | >7600 | >243 | >243 |
| methyl ether | | | |

(-), Fiducial limits were larger than 1000-fold.

Activity of Monoterpenes Against Parasitic Wasps. Egg parasitoids are among the best studied natural enemies and have been successfully used in biological control of various lepidopteran agricultural pests. They are easy to rear and kill their hosts before they hatch, thereby preventing crop damage. Previous analyses have indicated that essential oils from Ferula assafoetida can affect some biological and behavioral traits of Trichogramma embryophagum and T. Evanescens (Poorjavad, et al. (2014) BioControl 59:403-413). The LC₅₀ and LC₉₉ values of Prangos ferulacea essential oils against the egg stages of T. embryophagum were 2.12-5.66 μL/L air (Sümer Ercani, et al. (2013) Turk. J. Agric. Forest. 37:719-725).

Toxicity in terms of LC₅₀ (Table 11) , LC₉₀ (Table 12) and dose-response slopes (Table 13), or KD₅₀ (Table 14) of the monoterpenes to non-target species was assessed with two natural insect egg parasitic wasp species (T. chilonis and A. japonicus). The LT₅₀ values of all six compounds against A. japonicus were greater than DDVP (Table 14). In particular, the LT₅₀ of (+)-pulegone was approximately 1.2-fold greater than that of DDVP for A. japonicus (Table 14). (+)-Pulegone was also quite safe to T. chilonis with an LC₅₀ of 2.02 μg/cm³, which was greater than that of estragole (1.64 μg/cm³) and trans-anethole (0.62 μg/cm³), but lower than linalool (2.88 μg/cm³) (Table 11).

TABLE 11

| | LC₅₀ (fiducial limits) | | Chi- |
|---|---|---|---|
| Compound | (μg/cm³) against T. chilonis | | square |
| DDVP 80% | >3.75 | | 3.91 |
| (+)-Pulegone | 2.06 | (0.20-3.83) | 0.142 |
| Estragole | 1.64 | (0.00-3.19) | 3.94 |
| trans-Anethole | 0.62 | (0.00-3.16) | 3.72 |
| Linalool | 2.88 | (1.22-3.84) | 0.310 |
| Carvacrol | 826 | (0.00-2.53) | 3.71 |

| | | |
|---|---|---|
| Eugenol methyl ether | >60 | 0.197 |

TABLE 12

| | LC₉₀ (fiducial limits) (μg/cm³) | |
|---|---|---|
| Compound | against T. chilonis | |
| DDVP 80% | >3.75 | |
| (+)-Pulegone | 12.1 | (7.46-35.2) |
| Estragole | 34.9 | (17.2-762) |
| trans-Anethole | 19.6 | (5.60-2.25E11) |
| Linalool | 6.24 | (4.74-13.4) |
| Carvacrol | 7.08 | (1.55-60.8) |

| | |
|---|---|
| Eugenol methyl ether | >60 |

TABLE 13

| | Regression | |
|---|---|---|
| Compound | equation | Slope ± SE |
| DDVP 80% | 0.787x + 0.576 | 0.79 ± 0.55 |
| (+)-Pulegone | 0.963x + 0.202 | 1.7 ± 0.5 |
| Estragole | 0.963x + 0.220 | 0.96 ± 0.36 |
| trans-Anethole | 0.855x + 0.173 | 0.86 ± 0.43 |
| Linalool | 3.81x − 1.97 | 3.8 ± 1.2 |
| Carvacrol | 1.34x + 0.106 | 1.3 ± 0.6 |
| Eugenol methyl ether | 0.326x − 0.863 | 0.33 ± 0.31 |

TABLE 14

| | LT₅₀ (fiducial limits) (hour) |
|---|---|
| Compound | against A. japonicus |
| 80% DDVP | 0.41 (0.07-0.49) |
| (+)-Pulegone | 0.47 (0.00-0.68) |
| Estragole | 1.19 (1.02-1.37) |
| trans-Anethole | 0.933 (0.73-1.11) |
| Linalool | 0.788 (0.71-0.86) |
| Carvacrol | 3.32 (2.05-7220) |
| Eugenol methyl ether | 1.77 (1.49-2.23) |
| Acetone | >48^{a} |
| Chloroform | >48^{a} |

^{a}Less than 50% mortality were observed 48 hours after exposure.

Activity of Monoterpenes Against Honeybees. The honeybee (Apis mellifera) is the most frequent floral visitor of crops worldwide. Unfortunately, many of the same pesticides used to control unwanted insects also have a negative effect on honeybees. Accordingly, the toxicity of (+)-pulegone on honeybee Apis mellifera was assessed in a 24-hour fumigation assay. The results of this analysis are presented in Table 15.

TABLE 15

| Amount (μL/dm³) | No. of total bees | Mortality ± STD (%) |
|---|---|---|
| 0 (control) | 60 (20 × 3) | 5.0 ± 5.0 |
| 0.012 | 60 (20 × 3) | 5.0 ± 8.7 |
| 0.024 | 60 (20 × 3) | 3.3 ± 5.8 |
| 0.048 | 60 (20 × 3) | 5.0 ± 5.0 |
| 0.096 | 60 (20 × 3) | 5.0 ± 5.0 |
| 0.192 | 60 (20 × 3) | 8.3 ± 7.6 |

The results indicate that (+)-pulegone failed to have a negative impact on honeybees. Given that monoterpenes have also been shown to inhibit disease in honeybees, e.g., mites, bacteria and fungi (Tutun, et al. (2018) Turkish J. of Agricult. 6(1):34-45), there is an additional benefit to using the monoterpenes of this invention over conventional insecticides.

Toxicity of Monoterpenes Mixtures. A mixture of (+)-pulegone and estragole (1:1) had an LC₅₀ and LC₉₀ of 0.287 μg/cm³ (0.223-0.351 μg/cm³) and 0.443 μg/cm³ (0.362-0.723 μg/cm³), respectively. The co-toxicity coefficient (CTC) and synergistic factor (SF) were 67.9 and 0.679, respectively, which indicated antagonism as a bi-mixture (Table 15). A mixture of (+)-pulegone, estragole and trans-anethole (1:1:2) had LC₅₀ and LC₉₀ values of 0.654 μg/cm³ (0.539-0.771 μg/cm³) and 0.993 μg/cm³ (0.833-1.25 μg/cm³), respectively. The CTC and SF were 29.8 and 0.298, respectively, which indicated an antagonism of the monoterpene mixture (Table 16).

TABLE 16

| | (+)-Pulegone:Estragole | (+)-Pulegone:Estragole:trans- |
|---|---|---|
| Analysis | (1:1) | Anethole (1:1:2) |
| Regression | 7.124x + 3.707 | 7.398x + 1.202 |
| equation | | |
| LC₅₀ (fiducial | 0.287 (0.223-0.351) | 0.654 (0.539-0.771) |
| limits) (μg/cm³) | | |
| Chi-square | 0.075 | 0.009 |
| LC₉₀ (fiducial | 0.443 (0.362-0.723) | 0.993 (0.833-1.25) |
| limits) (μg/cm³) | | |
| CTC | 67.9 | 29.8 |
| SF | 0.679 | 0.298 |
| Type of action | Antagonist | Antagonist |

Field Applications. To assess the use of monoterpenes in the field, linalool was tested for control of flower Thrips in cowpea fields. Field control efficacy of linalool against Thrips indicated that linalool diluted 10-fold in peanut oil was the most efficacious application compared to 5- and 20-fold dilutions in peanut oil. At 1 and 3 days after treatment, control efficacy respectively reached 98% and 100% for the 10-fold dilution (Table 15). By comparison, the positive control, a 3000-fold dilution of spinetoram, reached 70% and 94% at 1 and 3 days after treatment, respectively (Table 17).

TABLE 16

| | Control Efficacy (%) | | | | | |
|---|---|---|---|---|---|---|
| | 1 | 3 | 5 | 7 | 14 | 21 |
| Treatments | DAT | DAT | DAT | DAT | DAT | DAT |

Thrips

| | | | | | | |
|---|---|---|---|---|---|---|
| Spinetoram | 70 | 94 | 37 | 33 | 62 | 0 |
| 20X Linalool | 74 | 61 | 67 | 20 | 39 | 0 |
| 10X Linalool | 98 | 100 | 34 | 38 | 6.4 | 0 |
| 5X Linalool | 71 | 97 | 37 | 2.2 | 49 | 0 |

Leafhopper

| | | | | | | |
|---|---|---|---|---|---|---|
| Spinetoram | 68 | 87 | 36 | 49 | 66 | 25 |
| 20X Linalool | 77 | 83 | 24 | 47 | 60 | 17 |
| 10X Linalool | 93 | 67 | 39 | 96 | 98 | 23 |
| 5X Linalool | 82 | 64 | 65 | 55 | 74 | 5.1 |

DAT, days after treatment.

A 10-fold dilution of linalool was also the most efficacious application, compared to 5- and 20-fold dilutions, in controlling leafhoppers, Cicadella viridi linne (Hemiptera: Cicadellidae). At 7 and 14 days after treatment, the control efficacy of the 10-fold dilution of linalool reached 96% and 98%, respectively. By comparison, at 7 and 14 days after treatment, the 3000-fold dilution of spinetoram reached 49% and 66%, respectively (Table 17).

Dose-Dependent Toxicity of (+)-Pulegone. To assess the specificity and dose-dependency of (+)-pulegone, mortality of Thrips M. usitatus was determined for (+)-pulegone and (−)-pulegone in a 24-hour fumigation assay over a range of concentrations (0, 0.012, 0.024, 0.048, 0.096 and 0.192 μL/dm³). The results of this analysis are presented in Table 18.

TABLE 18

| | | LC₅₀ | | fiducial |
|---|---|---|---|---|
| Compounds | equations | (μL/dm³) | R² | limits |
| (+)-pulegone | y = 2.110 x + 2.325 | 0.079 | 0.928 | 0.066-0.097 |
| (−)-pulegone | y = 2.958 x + 2.738 | 0.119 | 0.794 | |

Representative Bioinsecticidal Compositions. Formula I is prepared as an oil-in-water emulsion (Table 19).

TABLE 19

| Ingredient | Amount (% of total) |
|---|---|
| Water | 78.8% |
| Vegetable Oil (Peanut Oil or Corn Oil) | 8.0% |
| Linalool or (+)-pulegone | 10.0% |
| Soy Lecithin or polysorbate 20 | 2.0% |
| Sodium Bicarbonate | 1.0% |
| Benzoic Acid, Sodium Salt | 0.2% |
| Total: | 100% |

Formula II is prepared as an oil-in-water emulsion (Table 20).

TABLE 20

| Ingredient | Amount (% of total) |
|---|---|
| Water | 60% |
| Vegetable Oil (Peanut Oil or Corn Oil) | 30% |
| Linalool or (+)-pulegone | 10% |
| Total: | 100% |

### EXAMPLE 2: GABARAP AS A TARGET OF MONOTERPENOID INSECTICIDES

Chemicals. Anethole, aristolochic acid A, linalool and ME (Table 21) were purchased from (Aladdin Reagent, Shanghai, China). These monoterpenes and the positive control spinosyn A (Bosite Technology, Chongqing, China) were dissolved in acetone (10 g/L). The stock solution was then diluted 200 times with water to 100 mg/L. The diluted were then processed with 10% of TRITON™ X-100 (mass/volume) into an emulsifiable concentrate (20 mg/L), which was diluted with water for use according to the membrane and leaf-dipping methods (Minakuchi, et al. (2013) Applied Entomology and Zoology 48:507-513).

TABLE 21

| Compound | Structure |
|---|---|
| Methyl Eugenol (1- (3, 4-dimethoxyphenyl) -2- propene) | 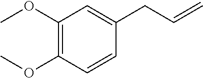 |
| Linalool (3,7-dimethylocta-1, 6-dien- 3-o1) | 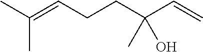 |
| Anethole (1-(4-methoxyphenyl) -1- propen) | 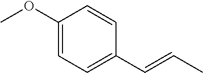 |
| Aristolochic acid (3,4-methylenedioxy-8- methoxy-10-nitro-1- phenanthrenecarboxylicacid) | 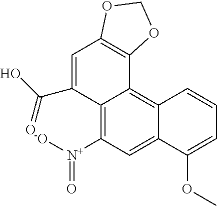 |
| Spinosyn A | 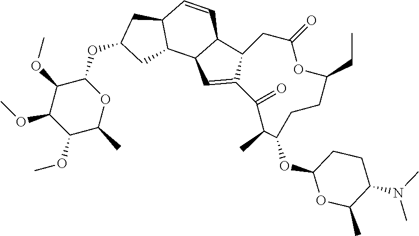 |

Insects. F. occidentalis Thrips were provided by the Institute of Vegetables and Flowers, Chinese Academy of Agricultural Sciences (Beijing, China), and kept in a box (19 cm×14 cm×20 cm) at 27±1° C., humidity of 50%-60% and a photoperiod of 16:8 h (light:dark). The population was established with sword beans (Canavalia gladiata). Second-instar nymphs with the same growth were tested.

Host Plants. Sword beans were purchased from a supermarket, soaked in the detergent Liby (0.2%) for 1-2 h to remove any possible pesticide residues. The beans were then rinsed with water and air-dried until there were no water drops on the surface of the beans prior to use.

Insect Assays. For membrane preparation, each of the target chemicals (ME, linalool, aristolochic acid A, anethole and spinosyn A) was dissolved in acetone and diluted to 40 mg/L. The prepared emulsifiable concentrate was then diluted with water to 0, 2.6, 3.8, 5.1, 7.7 and 10.2 mg/L. An aliquot of 0.5 mL of the solutions was placed in a 1.5 mL centrifuge tube, and vigorously shaken to coat the inner wall of the tube with a uniform film of the target chemical. The leaf blade (2 cm×3 cm) was immersed in the solution for 10 s in the test solution, and then air-dried until there were no water drops on the surface. The concentrations were the same as those used in the insecticide-impregnated membrane method. After the chemical film had been formed for 2 h, the infusion leaves were placed in the bottles. The second-instar nymphs were picked with a soft writing brush to make up ten insects per bottle. The bottles were sealed with plastic wrap. 1% Triton X-100 (m/V) aqueous solution as a blank control. Each treatment was repeated four times. The bottles were placed under temperature of 27±1° C., humidity of 50%-60% and photoperiod of 16:8 h (light:dark). The results were observed 24 h after treatment. To observe the results, all the insects were placed on a piece of black paper. The insects were touched with a soft brush and numbers of dead and living Thrips were recorded, followed by calculation of the mortality rates.

Preparation of recombinant GABARAP (rGABARAP) protein. RNA was extracted from F. occidentalis and cDNA was then synthesized. GABARAP (GenBank accession No. LOC113211372) was obtained after PCR amplification (Stafford-Banks, et al. (2014) Plos One 9:e94447).

The GABARAP gene was digested with NdeI and XhoI and then inserted into the pET32a vector. The pET32a-rGABARAP plasmid was extracted with the SanPrep Column Plasmid Mini-Preps Kit (Sangon Biotech, Shanghai, China). Plasmid-carrying cells were obtained by transforming the rGABARAP plasmids into Escherichia coli strain BL21(DE3) to confer ampicillin resistance. rGABARAP cells were cultured in Luria-Bertani (LB) medium. The cell cultures were maintained at 37° C. and induced with 1 mM of isopropyl-β-D-thiogalactopyranoside (IPTG) for protein production upon reaching an optical density at 600 nm (OD₆₀₀) to 0.6-1. After 16 h of induction at 16° C. the cells resuspended in 45 mL of lysis buffer (50 mM Tris-HCl, 150 mM NaCl, 1 mM ethylene diamine tetraacetic acid) were disrupted by sonication with the amplitude set at 45% for 30 min and centrifuged at 10760 g 4° C.

rGABARAP in the supernatant was purified with an AKTA™ purifier system (GE, Boston, MA) on a HISTRAP™ HP column (Cytiva, Marlborough, WA) and desalted on a HILOAD® SUPERDEX® 200 pg column (Cytiva). Briefly, the HISTRAP™ HP column was equilibrated with the binding buffer (50 mM Tris-HCl, 150 mM NaCl, 20 mM imidazole, 10% glycerol). The rGABARAP supernatant was then loaded on the HISTRAP™ HP column that was connected with a peristaltic pump (Leadfluid, Hebei, China). Non-target proteins were washed off from the column with the binding buffer at a flow rate of 3 mL/min. The elution buffer (50 mM Tris-HCl, 150 mM NaCl, 300 mM imidazole, 10% glycerol) was used to elute the target protein at a flow rate of 3 mL/min. The fractions containing the target protein were collected in a tube on ice as the elution was spectrophotometrically monitored at 280 nm. The purified protein was then further isolated on a size-exclusion chromatographic column (SUPERDEX® 200 pg, Cytiva). The SUPERDEX® 200 pg column was equilibrated, the target protein was injected into the loop ring from the injection port and eluted with the buffer (20 mM Tris-HCl, 150 mM NaCl, 10% glycerol) at a flow rate of 1 mL/min. The protein molecular weight was verified on 12% SDS-PAGE gels after being desalted. The bands were observed after Coomassie brilliant blue staining and decolorization.

Western blot analysis of rGABARAP. Western blot analysis was carried out to detect rGABARAP. The SDS-PAGE gel was transferred to the polyvinylidene fluoride (PVDF) membrane soaked in methanol. The PVDF membrane was blocked with western blot buffer (a mixture of phosphate-buffered saline (PBS), 5% skimmed milk and polysorbate 20) for 12 h at 4° C. The His-Tag Antibody specific antibody was added to PVDF membrane and incubated for 1-2 h at room temperature, and the PVDF membrane was washed 4 times with TBST buffer (a mixture of tris-buffered saline and polysorbate 20) for 10 min each time. The PVDF membrane was incubated in TBST buffer containing goat anti-mouse IgG serum (Cowin Bio, Beijing, China) for 1-2 h at room temperature. The PVDF membrane was washed 4 times with TBST buffer, each time for 10 min, followed by addition of chemiluminescent HRP substrate (Millipore, Boston, MA) at a ratio of 1:1 according to the size of the membrane. The gel images were taken under a Tanon S200 fluorescence and chemiluminescence gel imaging system (Tanon, Shanghai, China).

Mass spectrometry (MS) Analysis of rGABARAP. The SDS-PAGE gel was decolorized and washed with COOMASSIE brilliant blue decoloring solution (aqueous solution of 10% acetic acid and 5% ethanol). The target protein band on the gel was then cut into 0.5-0.7 mm cubes. Gel pieces were dehydrated with 100% acetonitrile. The protein disulfide bonds were reduced with dithiothreitol (DTT, 500 μL, 10 mM) at 56° C. for 30 min. Subsequently, iodoacetamide (500 μL, 55 mM) was added to alkylate the exposed cysteine residues at ambient temperature for 30 min. The gel pieces were vacuum dried, followed by addition of enzyme buffer (40 μL, 25 mM NH₄HCO₃, pH 8.0) and trypsin (5 μL, 0.01 μg/μL) (Mass Spec Grade, Promega, Madison, WI). The mixture was incubated at 37° C. for 12 h for trypsin digestion. After the digestion was completed, the alkylated peptides were collected from the gel by centrifugation and then were desalted with C18-ZIPTIP® (Millipore, Boston, MA). Finally, the extracts were combined and lyophilized to obtain tryptic peptides.

The tryptic peptides were dissolved in 2% acetonitrile aqueous solution and diluted to 1 μg/μL. The samples were analyzed on an Eksigent nanoLC-TripleTOF 5600 system (AB SCIEX, Boston, MA) equipped with a C18 capture column (AB SCIEX) and a C18 analytical column (Welch Materials, Shanghai, China). The tryptic peptides in the sample (5 μL) were trapped on a C18 capture column (AB SCIEX) and separated on a C18 analytical column (Welch Materials) with linear gradient elution programed from 2% to 98% aqueous acetonitrile containing 0.1% formic acid at a flow rate of 300 nL/min. MS1 spectra and MS2 spectra of 30 precursor ions were collected with dwell time of 250 ms and 50 ms, respectively, in the range of 350-1200 m/z and 100-1500 m/z. The MS/MS data were analyzed with ProteinPilot software (AB SCIEX) and searched by using the paragon algorithm in ProteinPilot against a F. occidentalis protein sequence database derived from the UniProt database.

Interaction between ME and rGABARAP. A Nano Temper Monolith NT.115 MST system (Nano Temper, Munich, Germany) was used to assess the binding affinities between the target compounds and rGABARAP according to the published procedures (Zan, et al. (2020) Journal of Agricultural and Food Chemistry 68:6280-6285). Spinosyn A was used as a chemical positive control. Spinosyn A (≥1 nM) can trigger a change of the Cl⁻ current of insect neuron GABA_{A}R, which is considered to be an insecticidal action mechanism of spinosyn A (Watson (2001) Pesticide Biochemistry and Physiology 71:20-28). Ovalbumin (OVA) (Sangon Biotech, Shanghai, China) is a control protein consisting of 385 amino acid residues. The interaction between OVA and ME was used as a protein control experiment (Huntington, et al. (1995) Protein Science 4:613-621).

The isothermal titration thermal binding measurements were performed with an ITC-200 calorimeter (GE Healthcare, Boston, MA) at 25° C. in a buffer containing 50 mM Tris-HCl and 100 mM NaCl (pH 7.4). Anethole, aristolochic acid A, linalool, ME, spinosyn A at 0.5 mM were titrated drop-wise into rGABARAP solution (0.05 mM) in a 280 μL sample cell, at 2 μL per drop (except 0.2 μL for the first drop) for a total of 19 drops, with an interval of 120 s. The MicroCal Origin 7.0 software system was used for data processing. The first run was a pre-run and was excluded from the final data. The amount of protein in the sample pool was constant. As the amount of the test compound increased, the amount of unbound protein decreased. The experimental bimolecular interaction data from the 18 drops were used to calculate the dissociation constant. The dissociation constant Ka was calculated as 1/K (Li, et al. (2018) RSC Advances 8:18952-18958).

ΔG=−RT in K(R=1.9872 cal mol⁻¹K⁻¹,T=298K)

ΔG=LH−TΔS

where T is the absolute temperature in kelvins (298 K); R is the gas constant (1.9872 cal mol⁻¹ K⁻¹) and K is the binding affinity; ΔH is the binding parameter reaction enthalpy change in cal/mol; ΔS is the reaction entropy change; and ΔG is the binding free energy.

Molecular Docking of ME with rGABARAP. No GABARAP crystal structure was available. The Swiss-Model was used to predict the GABARAP structure. The protein structure (PDB ID: 3M95) with the highest score (91.45%) was selected as the template for molecular docking based on scoring information such as sequence similarity (Morris, et al. (2008) Methods in Molecular Biology 443:365-382). The crystal structure of Bombyx mori autophagy-related (PDB ID: 3M95) was available from the RCSB protein data bank (Hu, et al. (2010) Acta Crystallographica 66:787-790). Structures of the target compounds were constructed with the Chem3D software (Bolton, et al. (2011) Journal of Cheminformatics 3:32). Autodock vina 1.1.2 was used for semiflexible docking of B. mori autophagy-related protein according to the published method (Morris, et al. (2008) Methods in Molecular Biology 443:365-382). PyMOL and Discovery Studio software was used to map the docking pattern of the highest-scoring conformation.

Preparation of rGABARAP Mutant and Interaction Between ME and rGABARAP Mutant. Molecular docking and computational simulation results indicated that ME and rGABARAP might have a π-π interaction through Tyr174 in comparison with the positive control spinosyn A. Therefore, site-directed mutagenesis was performed and tyrosine (Y174) was changed to alanine (A174). DNAman was used to convert the nucleic acid sequence into an amino acid sequence and find the Y174 site. Y174 was mutated to A174. The rGABARAP mutant gene loaded into the pMCSG19 vector and the His tags at both ends of the sequence were retained to construct a prokaryotic expression plasmid. The carrier contained a maltose binding protein (MBP) tag that was not cut for verification. However, MBP and ME were used as treatment controls. The mutant plasmid was constructed in Sangon Biotech (Shanghai, China). The protein expression, purification, and desalting procedures of rGABARAP^{Y174A} mutant and rGABARAP were the same. Subsequently, the binding kinetics of ME and rGABARAP^{Y174A} were tested by MST and ITC.

Statistical Analysis. Statistical analysis was performed with NT Affinity Analysis v2.3 software (Nano Temper, Munich, Germany), MicroCal Origin 7.0 software (GE Healthcare) and ProteinPilot software (AB SCIEX) for MST, ITC and MS data analysis. Autodock vina 1.1.2, PyMOL and Discovery Studio program for molecular docking and visualization analysis. The protein data of F. occidentalis is searched in the database UniProt by the paragon algorithm in ProteinPilot.

Potency of Target Chemicals Against F. occidentalis. The half-maximum lethal concentration (LC₅₀) values were ranked from high to low as follow: aristolochic acid A>linalool>anethole>spinosyn A>ME (Table 21).

TABLE 21

| | | | LC₅₀ | |
|---|---|---|---|---|
| Chemical | Equation | x² (df) | (mg · L⁻¹) | 95% CI |
| Anethole | y = 0.639x- | 0.672 (3) | 4.6 | 1.6-11 |
| | 0.426 | | | |
| Linalool | y = 1.095x- | 2.422 (3) | 7.0 | 4.6-12 |
| | 0.924 | | | |
| Aristolochic | y = 0.750x- | 0.287 (3) | 40 | 16-6000 |
| acid A | 1.202 | | | |
| Methyl | y = 0.778x- | 4.233 (3) | 1.1 | 0.6-2.1 |
| eugenol | 0.046 | | | |
| Spinosyn A | y = 0.876x- | 0.499 (3) | 1.6 | 1.0-4.2 |
| | 0.176 | | | |

df means degree of freedom, it is the number of freely valued variables.

Prokaryotic Expression and Purification of Target Protein. The pET32a-rGABARAP plasmid was successfully transferred into BL21(DE3) cells. After cultivation overnight at 37° C., a single clone was picked for an induction expression test. The results showed expression of rGABARAP at 16° C., as displayed by SDS-PAGE gel. After induction of expression, the protein band of rGABARAP was at 19 kDa. The rGABARAP protein was purified via size-exclusion chromatography and verified on SDS-PAGE gel, as a clear band near 19 kDa. The size-exclusion chromatogram showed only a single peak of the target protein in the 16-18 mL fractions, indicating existence of rGABARAP as a monomer. The western blot results showed a band at 17 kDa-20 kDa, which was consistent with the molecular mass of the target protein of 19 kDa determined with MS. In addition, the amino acid sequence coverage as determined with TripTOF™ 5600 analysis was 100%. The results showed that the purified protein was GABARAP.

Binding Constants Between Target Chemicals and rGABARAP. A number of different compounds were tested for their binding affinities with rGABARAP. The K_{d} values as determined by MST and ITC are presented in Table 23.

TABLE 23

| | K_{d} value (μmol/L) | |
|---|---|---|
| Chemical | MST | ITC* |
| Anethole | 1.61 | 4.49 |
| Linalool | 12.3 | 6.89 |
| Aristolochic acid A | 146 | no binding |
| Methyl eugenol | 1.30 | 4.22 |
| R- (+) -pulegone | 1.72 | — |
| S-(-) -pulegone | 2.53 | — |
| 1:1 R- (+) -pulegone: | 2.06 | — |
| S-(-) -pulegone | | |
| Spinosyn A | 0.05 | 3.74 |

*water to water was a blank control.

The interaction between OVA and ME was used as a control experiment. The K_{d} value of rGABARAP with ME (1.30 μmol/L) is 26-fold greater than that with spinosyn A (0.05 μM) as determined by MST, whereas the Ka values of rGABARAP with ME and spinosyn A are similar (4.22 μM vs 3.74 μM) as determined by ITC. MST detection requires the target protein being labeled at a constant concentration, while a non-fluorescent labeled molecule can be diluted to a series of concentrations. The nature of buffer solution is very important in MST detection, which affects the background fluorescence value. A buffer solution that produces the smallest signal-to-noise ratio at the specific wavelength of the fluorophore is considered optimum. In addition, high concentrations of proteins likely produce high background fluorescence values during MST measurements. There are a number of parameters that can lead to MST measurement errors. ITC has some advantages over MST. ITC does not have any restrictions on the solvent properties, spectral properties and electrical properties of the studied system, that is, it has the unique advantage of non-specificity. In general, ITC measurements are fast and accurate. The amount of sample required for an ITC measurement is small. The degree of intermolecular interaction can be specifically measured via thermodynamic reactions. These advantages allow ITC to accurately measure protein-ligand interactions. The MST and ITC results demonstrated that ME has a strong binding force with rGABARAP in vitro.

Molecular Docking on rGABARAP. Exploring protein ligand binding sites provides valuable information for molecular design and structure-activity studies. The docking of target compounds with rGABARAP molecule was carried out. The docking score of ME and rGABARAP was −12.3 kcal/mol. The complex involved a π-π interaction between ME and Y174 and a hydrophobic interaction between ME and F187 and F133. Anethole formed hydrophobic interactions with amino acids F133 and F187, having a H-bond with R91 and π-π interaction with Y174. Linalool formed hydrophobic interactions with Y38 and F187, and one H-bond with F133. Aristolochic acid A had hydrophobic interactions with Y174 and π-π interactions with Y38. Spinosyn A had hydrophobic interactions with F19, Y174, F133 and I79 and two H bonds with N21 and R91. S-(−)-Pulegone interacts with Lys46 and Leu50 via H-bond and with Tyr49, Val51, Phe60, Leu55, Pro52 via hydrophobic bonds. R-(+)-Pulegone interacts with Arg67 via H bond, and with Tyr49, Val51, Phe60, Leu55, Pro52 via hydrophobic bond.

The binding strength of ME, anethole, linalool, aristolochic acid A and spinosyn A, as determined by ΔGcal, was −12.3, −4.00, −2.24, −6.76 and −9.62 kcal/mol. ME had the highest binding affinity.

Interactions between the target chemicals and rGABARAP were assessed through molecular docking and molecular simulation to explore the binding strength, action site and involvement of key amino acids. Preliminary experiments showed that the ME potentially formed a π-π interaction with Y174 to yield high binding affinity. A mutation of Y174 to A174 was performed to verify the contribution of Y174 to the binding between ME and rGABARAP.

No Interactions Between ME and rGABARAP^{Y174A}. Site-directed mutagenesis and MST experiments verified loss of binding between rGABARAP^{Y174A} and ME. In the ITC controlled trial, neither MBP nor ME interacted with rGABARAP^{Y174A}, indicating a key role of Y174 in the interaction of rGABARAP and ME. Binding interactions between rGABARAPY174A and anethole, spinosyn A, aristolochic acid A, and linalool were also determined by MST and ITC (Table 24).

TABLE 24

| | K_{d} value (μmol/L) | |
|---|---|---|
| Chemical | MST | ITC |
| Anethole | 41.05 ± 36.45 | No binding |
| Linalool | 16.27 ± 6.79 | 8.92 |
| Aristolochic acid A | 158 ± 82 | No binding |
| Spinosyn A | 0.93 ± 0.35 | 3.86 |

The discovery of new targets is of great significance for the control of Thrips that spread viruses and harm crops. It is known that GABA_{A}R is a major target of insecticides that include cyclodienes, meta-diamide insecticides, fipronil, spinosyn, avermectins, and the like (Casida (2009) Chemical research in toxicology 22:609-619). Most studies of GABARAP, however, have been focused on mammalian GABARAP (Priestley, et al. (2003) British Journal of Pharmacology 140:1363-1372). There have been reports on insect GABARAP, which show that GABARAP interacts with GABA_{A}R subunits in insects (Priestley, et al. (2003) British Journal of Pharmacology 140:1363-1372), while hexachlorocyclohexane binds to GABA_{A}R subunits to produce insecticidal effects (Casida (2009) Chemical research in toxicology 22:609-619). This study shows that Y174 is a key site for binding of rGABARAP and ME and indicates that GABARAP is a viable target for insecticides. GABARAP is responsible for GABA receptor localization, trafficking, stabilization, regulation, and modulation, and synaptic plasticity. Therefore, the monoterpenes such as ME and (+)-pulegone act on GABARAP instead of GABA_{A}R, which indicates high potentials that these monoterpenes and analogs will not have cross resistance with the current insecticides that act on the GABA_{A}R.

What is claimed is:

1. A method for controlling an insect pest in a space or soil infested with the insect pest comprising fumigating the space or soil with a bioinsecticidal composition comprising an effective amount of a monoterpene of Formula I: 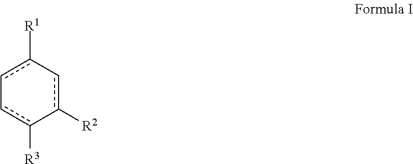
wherein dashed bonds are independently present or absent; R¹ and R³ are independently alkyl, alkenyl, or alkoxyl; R² ishydrogen, hydroxyl, or oxo; and tautomers, isomers or enantiomers thereof, thereby controlling the insect pest in the space or soil.

2. The method of claim 1, wherein the monoterpene of Formula I is pulegone or methyl eugenol.

3. The method of claim 1, wherein the insect pest is a thrip, fruit fly of the genus Drosophila, and/or white fly.

4. A method for controlling an insect pest in a space or soil infested with the insect pest comprising fumigating the space or soil with a monoterpene that binds to a GABA receptor-associated protein of the insect pest thereby controlling the insect pest in the space of soil.

5. The method of claim 4, wherein the monoterpene has the structure of Formula I: 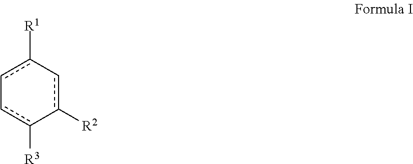
wherein dashed bonds are independently present or absent; R¹ and R³ are independently alkyl, alkenyl, or alkoxyl; R² ishydrogen, hydroxyl, or oxo; and tautomers, isomers or enantiomers thereof.

6. The method of claim 5, wherein the monoterpene of Formula I is pulegone or methyl eugenol.

7. The method of claim 4, wherein the insect pest is a thrip, fruit fly of the genus Drosophila, and/or white fly.
